(19) United States
(12) Patent Application Publication
(10) Pub. No.: US 2024/0075609 A1
(43) Pub. Date: Mar. 7, 2024

(54) POWER TOOL

(71) Applicant: MAKITA CORPORATION, Anjo-shi (JP)

(72) Inventors: Ding ZHAO, Anjo-shi (JP); Yuta SUZUKI, Anjo-shi (JP); Tomoya HATTORI, Anjo-shi (JP)

(73) Assignee: MAKITA CORPORATION, Anjo-shi (JP)

(21) Appl. No.: 18/235,112

(22) Filed: Aug. 17, 2023

(30) Foreign Application Priority Data
Sep. 1, 2022 (JP) 2022-139089
Jun. 29, 2023 (JP) 2023-107516

(51) Int. Cl. B25F 5/02

(52) U.S. Cl. CPC B25F 5/02

(57) ABSTRACT

A power tool is less likely to have lower workability. A power tool includes a motor including a rotor rotatable about a rotation axis extending in a front-rear direction and a stator, an output unit located frontward from the motor and rotatable in response to a rotational force from the rotor, a motor compartment accommodating the motor, a grip extending downward from the motor compartment, a rear rotor bearing supporting a rear portion of the rotor, and a rear cover covering an opening at a rear end of the motor compartment and holding the rear rotor bearing. The motor compartment includes a guide that guides the rear cover in a first circumferential direction and frontward, a front-rear restrictor that restricts front-rear movement of the rear cover, and a circumferential restrictor that restricts circumferential movement of the rear cover.

### CROSS-REFERENCE TO RELATED APPLICATIONS

This application claims the benefit of priority to Japanese Patent Application No. 2022-139089, filed on Sep. 1, 2022, and Japanese Patent Application No. 2023-107516, filed on Jun. 29, 2023, the entire contents of which are hereby incorporated by reference.

### BACKGROUND

### 1. Technical Field

The present disclosure relates to a power tool.

### 2. Description of the Background

In the technical field of power tools, a power tool is known as described in Japanese Unexamined Patent Application Publication No. 2007-295773. The power tool includes a main case accommodating a direct current (DC) brushless motor and a rear case closing the rear of the main case. The rear case is fastened to the rear of the main case with two screws.

### BRIEF SUMMARY

To fasten the rear case to the rear of the main case with the two screws, the rear case and the main case each include bosses. When the bosses protrude from the rear case and the main case in the lateral direction, the power tool may be less operable in a narrow space near, for example, a wall. With the rear case fastened to the rear of the main case with the two screws, the power tool may be assembled less easily.

One or more aspects of the present disclosure are directed to a power tool that is less likely to have lower workability and is less likely to have difficulty in assembly.

A first aspect of the present disclosure provides a power tool, including:
a motor including a rotor and a stator, the rotor being rotatable about a rotation axis extending in a front-rear direction;
an output unit located frontward from the motor and rotatable in response to a rotational force from the rotor;
a motor compartment accommodating the motor;
a grip extending downward from the motor compartment;
a rear rotor bearing supporting a rear portion of the rotor; and
a rear cover covering an opening at a rear end of the motor compartment, the rear cover holding the rear rotor bearing,
wherein the motor compartment includes
   a guide configured to guide the rear cover in a first circumferential direction and frontward,
   a front-rear restrictor configured to restrict front-rear movement of the rear cover being guided by the guide, and
   a circumferential restrictor configured to restrict circumferential movement of the rear cover being restricted from the front-rear movement.

A second aspect of the present disclosure provides a power tool, including:
a motor including a rotor and a stator, the rotor being rotatable about a rotation axis extending in a front-rear direction;
an output unit located frontward from the motor and rotatable in response to a rotational force from the rotor;
a left motor compartment and a right motor compartment accommodating the motor;
a grip extending downward from the left motor compartment and the right motor compartment;
a rear rotor bearing supporting a rear portion of the rotor; and
a rear cover fastened to the left motor compartment and the right motor compartment fastened together only through engagement with a rear of the left motor compartment and a rear of the right motor compartment, the rear cover holding the rear rotor bearing.

A third aspect of the present disclosure provides a power tool, including:
a motor including a rotor and a stator, the rotor being rotatable about a rotation axis extending in a front-rear direction;
an output unit located frontward from the motor and rotatable in response to a rotational force from the rotor;
a motor compartment accommodating the motor;
a rear rotor bearing supporting a rear portion of the rotor; and
a first rear cover covering an opening at a rear end of the motor compartment and holding the rear rotor bearing, the first rear cover being replaceable with a second rear cover different from the first rear cover in shape.

A fourth aspect of the present disclosure provides a power tool, including:
a motor including a rotor and a stator, the rotor being rotatable about a rotation axis extending in a front-rear direction;
an output unit located frontward from the motor and rotatable in response to a rotational force from the rotor;
a motor compartment accommodating the motor;
a rear rotor bearing supporting a rear portion of the rotor; and
a first rear cover covering an opening at a rear end of the motor compartment and holding the rear rotor bearing, the first rear cover and the motor compartment being fastened together through engagement with each other, the first rear cover being replaceable with a second rear cover different from the first rear cover in color.

A fifth aspect of the present disclosure provides a power tool, including:
a motor including a rotor and a stator, the rotor being rotatable about a rotation axis extending in a front-rear direction;
an output unit located frontward from the motor and rotatable in response to a rotational force from the rotor;
a motor compartment accommodating the motor;
a rear rotor bearing supporting a rear portion of the rotor; and
a first rear cover covering an opening at a rear end of the motor compartment and holding the rear rotor bearing, the first rear cover being replaceable with a second rear cover different from the first rear cover in composition.

The power tool according to the above aspects of the present disclosure is less likely to have lower workability and is less likely to have difficulty in assembly.

### BRIEF DESCRIPTION OF DRAWINGS

FIG. 1 is a front perspective view of a power tool according to a first embodiment.

FIG. 2 is a side view of the power tool according to the first embodiment.

FIG. 3 is a rear perspective view of an upper portion of the power tool according to the first embodiment.

FIG. 4 is a rear view of the upper portion of the power tool according to the first embodiment.

FIG. 5 is a side view of the upper portion of the power tool according to the first embodiment.

FIG. 6 is a longitudinal sectional view of the upper portion of the power tool according to the first embodiment.

FIG. 7 is a horizontal sectional view of the upper portion of the power tool according to the first embodiment.

FIG. 8 is an exploded perspective view of the upper portion of the power tool according to the first embodiment as viewed from the rear.

FIG. 9 is a front perspective view of a rear cover in the first embodiment.

FIG. 10 is a right side view of the rear cover in the first embodiment.

FIG. 11 is a left side view of the rear cover in the first embodiment.

FIG. 12 is a top view of the rear cover in the first embodiment.

FIG. 13 is a bottom view of the rear cover in the first embodiment.

FIG. 14 is a rear view of the rear cover in the first embodiment.

FIG. 15 is a front view of the rear cover in the first embodiment.

FIG. 16 is a rear view of an upper rear portion of the power tool according to the first embodiment without the rear cover.

FIG. 17 is a perspective view of the upper rear portion of the power tool according to the first embodiment without the rear cover as viewed from the right rear.

FIG. 18 is a perspective view of the upper rear portion of the power tool according to the first embodiment without the rear cover as viewed from the left rear.

FIG. 19 is a right side view of the upper rear portion of the power tool according to the first embodiment without the rear cover.

FIG. 20 is a left side view of the upper rear portion of the power tool according to the first embodiment without the rear cover.

FIG. 21 is a cross-sectional view of the rear cover in the first embodiment, describing its fastening.

FIG. 22 is a cross-sectional view of the rear cover in the first embodiment, describing its fastening.

FIG. 23 is a cross-sectional view of the rear cover in the first embodiment, describing its fastening.

FIG. 24 is a cross-sectional view of the rear cover in the first embodiment, describing its fastening.

FIG. 25 is a cross-sectional view of the rear cover in the first embodiment, describing its unfastening.

FIG. 26 is a rear perspective view of an upper portion of a power tool according to a second embodiment.

FIG. 27 is a rear perspective view of an upper portion of a power tool according to a third embodiment.

FIG. 28 is a schematic diagram of a power tool according to a fourth embodiment.

FIG. 29 is a rear perspective view of a power tool according to a fifth embodiment.

FIG. 30 is a rear view of a rear cover in the fifth embodiment.

FIG. 31 is a side view of a power tool according to a sixth embodiment.

FIG. 32 is a rear perspective view of a power tool according to a seventh embodiment.

FIG. 33 is a side view of an upper portion of the power tool according to the seventh embodiment.

FIG. 34 is a rear perspective view of the power tool according to the seventh embodiment.

FIG. 35 is a rear perspective view of a power tool according to an eighth embodiment.

FIG. 36 is a rear perspective view of the power tool according to the eighth embodiment.

FIG. 37 is a rear perspective view of a power tool according to a ninth embodiment.

FIG. 38 is a rear perspective view of the power tool according to the ninth embodiment.

FIG. 39 is a rear perspective view of a power tool according to a tenth embodiment.

FIG. 40 is a side view of an upper portion of the power tool according to the tenth embodiment.

FIG. 41 is a rear perspective view of a power tool according to an eleventh embodiment.

FIG. 42 is a side view of an upper portion of the power tool according to the eleventh embodiment.

FIG. 43 is a rear perspective view of a power tool according to a twelfth embodiment.

FIG. 44 is a rear perspective view of a power tool according to a thirteenth embodiment.

FIG. 45 is a front perspective view of a power tool according to a fourteenth embodiment.

FIG. 46 is a rear perspective view of the power tool according to the fourteenth embodiment.

FIG. 47 is a side view of an upper portion of the power tool according to the fourteenth embodiment.

FIG. 48 is a front view of the upper portion of the power tool according to the fourteenth embodiment.

FIG. 49 is a horizontal sectional view of the upper portion of the power tool according to the fourteenth embodiment.

FIG. 50 is a rear perspective view of a power tool according to a fifteenth embodiment.

FIG. 51 is a rear view of an upper portion of the power tool according to the fifteenth embodiment.

FIG. 52 is a horizontal sectional view of an upper portion of a power tool according to a sixteenth embodiment.

FIG. 53 is a horizontal sectional view of an upper portion of a power tool according to a seventeenth embodiment.

FIG. 54 is a rear perspective view of a power tool according to an eighteenth embodiment.

FIG. 55 is a rear view of an upper portion of the power tool according to the eighteenth embodiment.

FIG. 56 is a rear perspective view of a power tool according to a nineteenth embodiment.

FIG. 57 is a schematic diagram of a power tool according to a twentieth embodiment.

### DETAILED DESCRIPTION

One or more embodiments will now be described with reference to the drawings. In the embodiments, the positional relationships between the components will be described using the directional terms such as right and left (or lateral), front and rear (or frontward and rearward), and up and down (or vertical). The terms indicate relative positions or directions with respect to the center of a power tool 1. The power tool 1 includes a motor 6 as a power source.

In the embodiments, a direction parallel to a rotation axis AX of the motor 6 is referred to as an axial direction for convenience. A direction about the rotation axis AX is referred to as a circumferential direction or circumferentially, or a rotation direction for convenience. A direction radial from the rotation axis AX is referred to as a radial direction or radially for convenience.

The rotation axis AX extends in the front-rear direction. A first axial direction is from the rear to the front. A second axial direction is from the front to the rear. A position nearer the rotation axis AX in the radial direction, or a radial direction toward the rotation axis AX, is referred to as radially inside or radially inward for convenience. A position farther from the rotation axis AX in the radial direction, or a radial direction away from the rotation axis AX, is referred to as radially outside or radially outward for convenience. A predetermined circumferential direction is referred to as a first circumferential direction for convenience. The direction opposite to the first circumferential direction is referred to as a second circumferential direction for convenience.

### 1. First Embodiment

### Power Tool

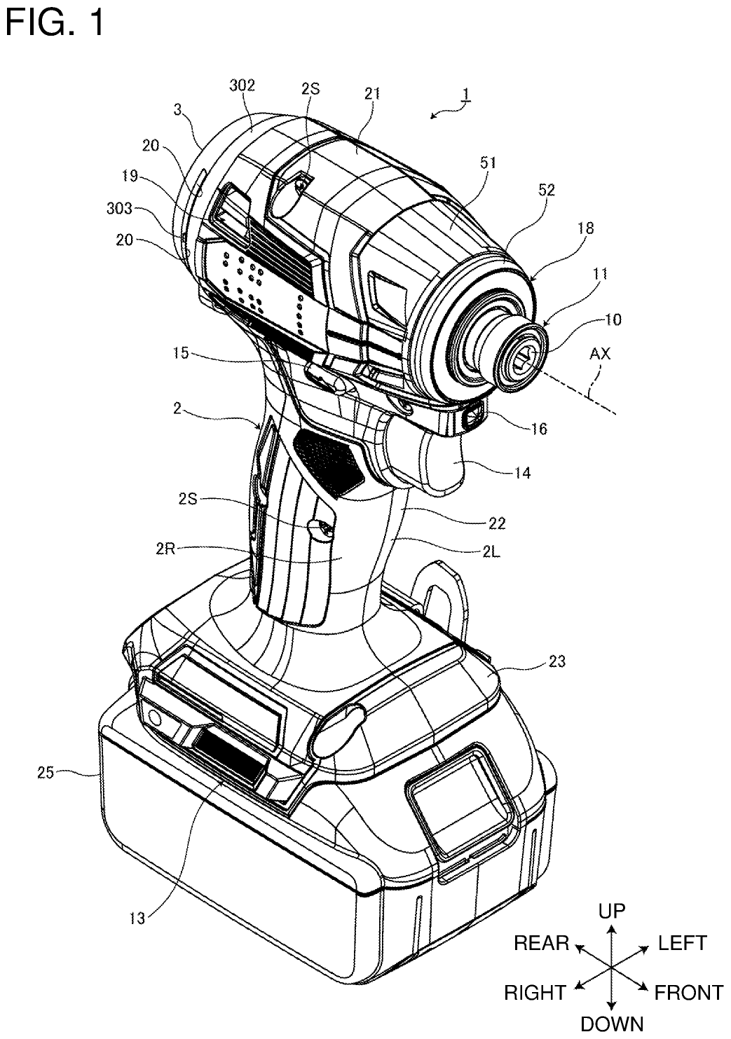

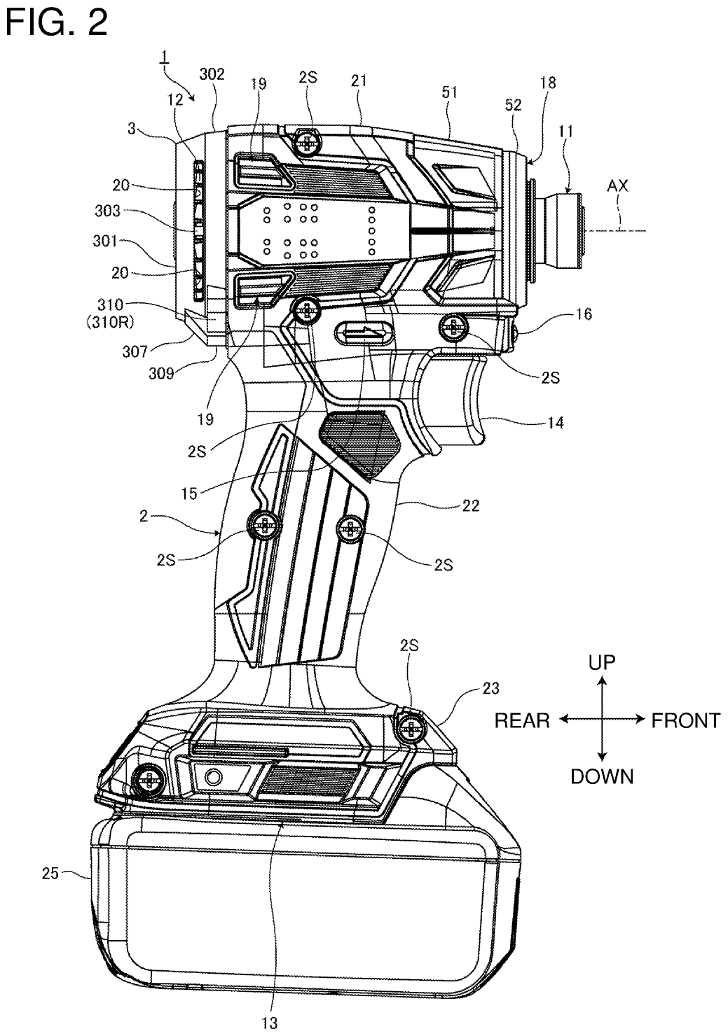

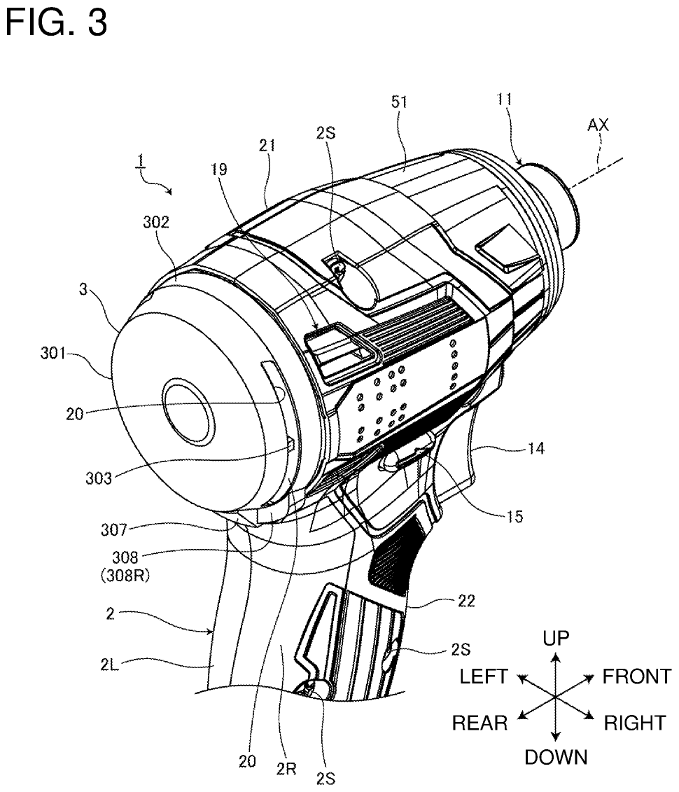

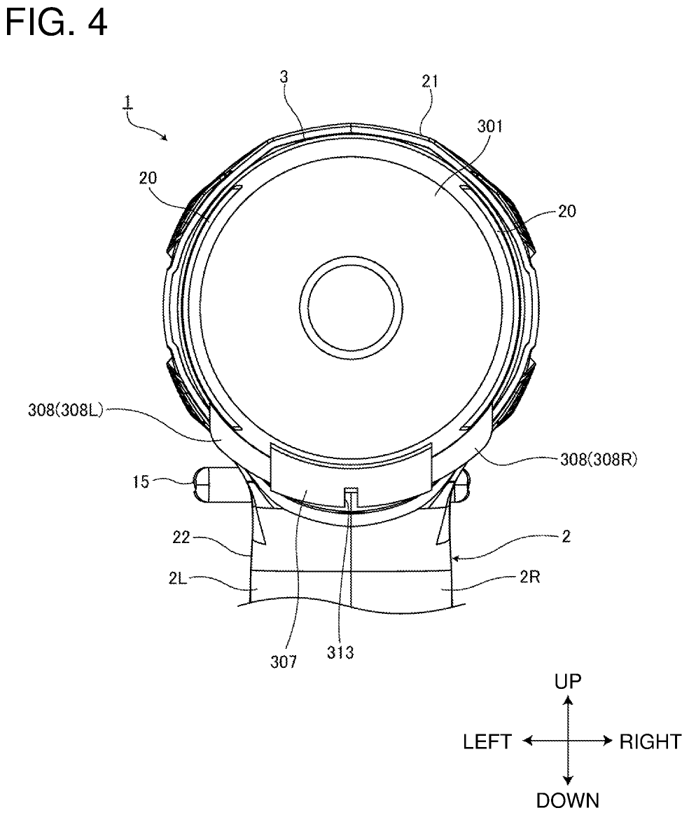

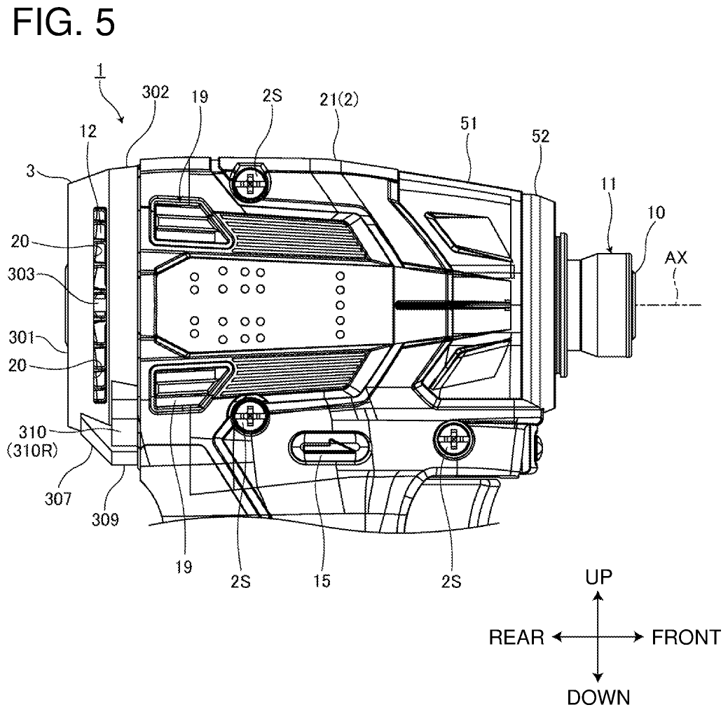

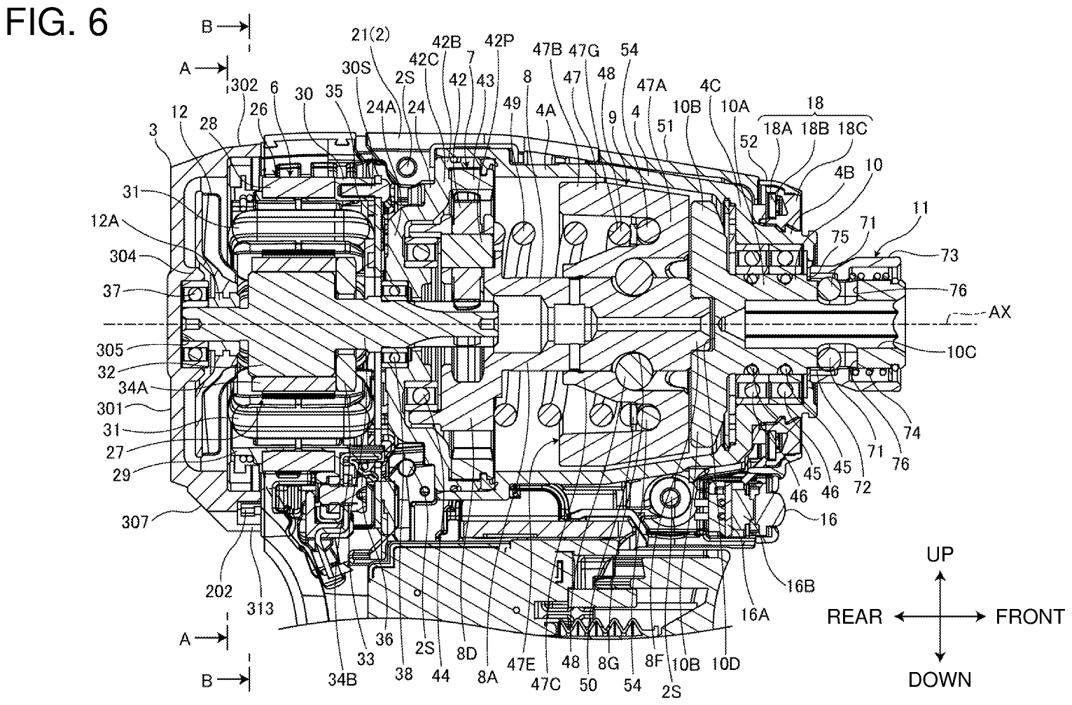

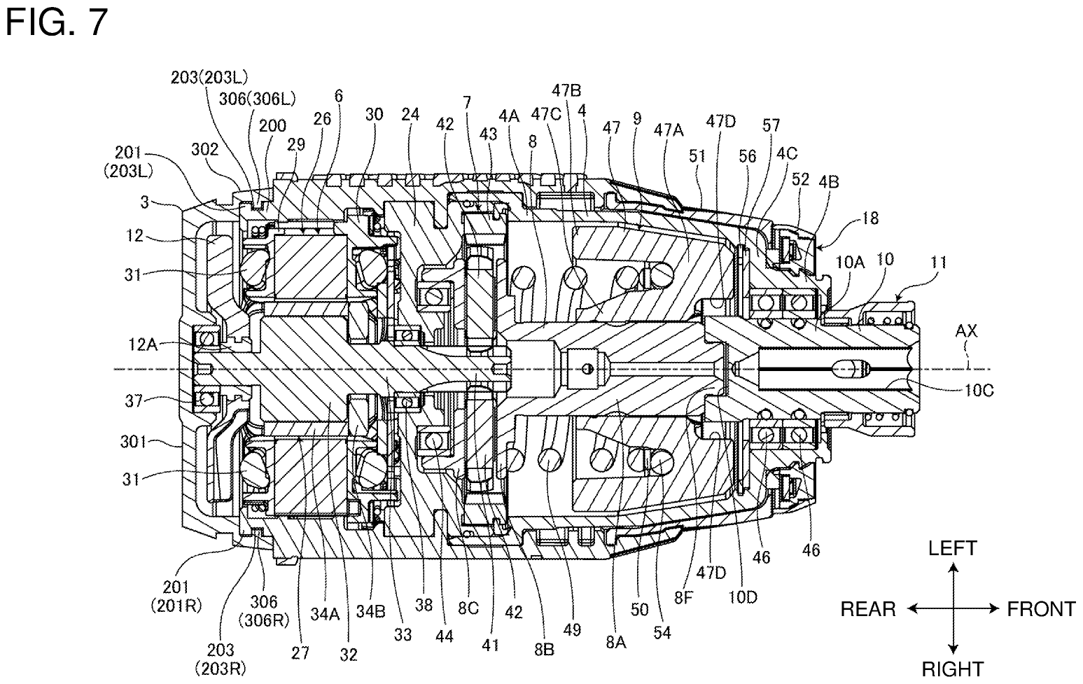

FIG. 1 is a front perspective view of the power tool 1 according to the present embodiment. FIG. 2 is a side view of the power tool 1. FIG. 3 is a rear perspective view of an upper portion of the power tool 1. FIG. 4 is a rear view of the upper portion of the power tool 1. FIG. 5 is a side view of the upper portion of the power tool 1. FIG. 6 is a longitudinal sectional view of the upper portion of the power tool 1. FIG. 7 is a horizontal sectional view of the upper portion of the power tool 1.

The power tool 1 according to the embodiment is an impact driver, which is an example of a screwing tool. The power tool 1 includes a housing 2, a rear cover 3, a hammer case 4, a bearing box 24, a hammer case cover 51, the motor 6, a reducer 7, a spindle 8, a striker 9, an anvil 10, a tool holder 11, a fan 12, a battery mount 13, a trigger lever 14, a forward-reverse switch lever 15, a mode switch hand button 16, a light assembly 18, and a light cover 52.

The housing 2 is formed from a synthetic resin. The housing 2 in the embodiment is formed from nylon. The housing 2 includes a left housing 2L and a right housing 2R. The right housing 2R is located on the right of the left housing 2L. The left housing 2L and the right housing 2R are fastened together with multiple screws 2S. The housing 2 includes a pair of housing halves.

The housing 2 includes a motor compartment 21, a grip 22, and a battery holder 23.

The motor compartment 21 accommodates the motor 6. The motor compartment 21 accommodates at least a part of the hammer case 4. The motor compartment 21 is cylindrical.

A portion of the left housing 2L serving as the motor compartment 21 is hereafter referred to as a left motor compartment for convenience. A portion of the right housing 2R serving as the motor compartment 21 is hereafter referred to as a right motor compartment for convenience.

The grip 22 is grippable by an operator. The grip 22 extends downward from the motor compartment 21. The grip 22 extends downward from the left motor compartment and the right motor compartment. The trigger lever 14 is located in an upper portion of the grip 22.

The battery holder 23 holds a battery pack 25 with the battery mount 13. The battery holder 23 is connected to the lower end of the grip 22. The battery holder 23 has larger outer dimensions than the grip 22 in the front-rear direction and in the lateral direction.

The rear cover 3 covers an opening at the rear end of the motor compartment 21. The rear cover 3 is located behind the motor compartment 21. The rear cover 3 accommodates at least a part of the fan 12. The fan 12 is located inward from the rear cover 3. The rear cover 3 holds a rear rotor bearing 37. The rear cover 3 is formed from a synthetic resin. The rear cover 3 is fastened to the rear end of the motor compartment 21.

The motor compartment 21 has inlets 19. The rear cover 3 has outlets 20. Air outside the housing 2 flows into an internal space of the housing 2 through the inlets 19, and then flows out of the housing 2 through the outlets 20.

The hammer case 4 accommodates at least a part of the reducer 7, the spindle 8, the striker 9, and at least a part of the anvil 10. The hammer case 4 is formed from a metal. The hammer case 4 in the embodiment is formed from aluminum. The hammer case 4 is cylindrical. The hammer case 4 includes a larger cylinder 4A, a smaller cylinder 4B, and a connecting portion 4C. The smaller cylinder 4B is located frontward from the larger cylinder 4A. The front end of the larger cylinder 4A and the rear end of the smaller cylinder 4B are connected to each other with the connecting portion 4C in between. The connecting portion 4C is annular. The larger cylinder 4A has a larger outer diameter than the smaller cylinder 4B. The larger cylinder 4A has a larger inner diameter than the smaller cylinder 4B.

The bearing box 24 accommodates at least a part of the reducer 7. The bearing box 24 holds a front rotor bearing 38 and a spindle bearing 44. The bearing box 24 is formed from a metal. The bearing box 24 is fastened to a rear portion of the hammer case 4. The bearing box 24 includes a rear annular portion 24A and a front annular portion 24B. The front annular portion 24B is located frontward from the rear annular portion 24A. The front end of the rear annular portion 24A and the rear end of the front annular portion 24B are connected to each other with a connecting portion 24C in between. The connecting portion 24C is annular. The rear annular portion 24A has a smaller outer diameter than the front annular portion 24B. The rear annular portion 24A has a smaller inner diameter than the front annular portion 24B. The bearing box 24 and the hammer case 4 may be fastened together by screwing or by fitting. For example, the front annular portion 24B may have threads on its outer circumference, and the larger cylinder 4A may have threaded grooves on its inner circumference. The threads on the front annular portion 24B may be engaged with the threaded grooves on the larger cylinder 4A to fasten the bearing box 24 and the hammer case 4 together. The front annular portion 24B may be fitted in the larger cylinder 4A to fasten the bearing box 24 and the hammer case 4 together. The front rotor bearing 38 is located radially inward from the rear annular portion 24A. The spindle bearing 44 is located radially inward from the connecting portion 24C.

The hammer case 4 is held between the left housing 2L and the right housing 2R. The hammer case 4 includes the rear portion accommodated in the motor compartment 21. The hammer case 4 is connected to the front of the motor compartment 21. The bearing box 24 is fixed to the motor compartment 21 and the hammer case 4.

The hammer case cover 51 protects the hammer case 4. The hammer case cover 51 prevents contact between the hammer case 4 and objects nearby. The hammer case cover 51 covers the outer circumferential surface of the larger cylinder 4A. The hammer case cover 51 may be eliminated.

The motor 6 is a power source for the power tool 1. The motor 6 is an inner-rotor brushless motor. The motor 6 includes a stator 26 and a rotor 27. The stator 26 is supported on the motor compartment 21. The rotor 27 is at least partially located inward from the stator 26. The rotor 27 rotates relative to the stator 26. The rotor 27 rotates about the rotation axis AX extending in the front-rear direction.

The stator 26 includes a stator core 28, a rear insulator 29, a front insulator 30, and multiple coils 31.

The stator core 28 includes multiple steel plates stacked on one another. The steel plates are metal plates formed from iron as a main component. The stator core 28 is cylindrical. The stator core 28 is located radially outward from the rotor 27. The stator core 28 includes multiple teeth to support the coils 31.

The rear insulator 29 and the front insulator 30 are electrical insulating members formed from a synthetic resin. The rear insulator 29 and the front insulator 30 each electrically insulate the stator core 28 and the coils 31. The rear insulator 29 is fixed to the rear of the stator core 28. The front insulator 30 is fixed to the front of the stator core 28. The rear insulator 29 partially covers the surfaces of the teeth. The front insulator 30 partially covers the surfaces of the teeth.

The coils 31 are attached to the stator core 28 with the rear insulator 29 and the front insulator 30 in between. The coils 31 surround the teeth on the stator core 28 with the rear insulator 29 and the front insulator 30 in between. The coils 31 and the stator core 28 are electrically insulated from each other with the front insulator 30 and the rear insulator 29 in between. The coils 31 are connected to one another with fusing terminals 36.

The rotor 27 rotates about the rotation axis AX. The rotor 27 includes a rotor core 32, a rotor shaft 33, a rotor magnet 34A, and a sensor magnet 34B.

The rotor core 32 and the rotor shaft 33 are formed from steel. In the embodiment, the rotor core 32 is integral with the rotor shaft 33. The rotor shaft 33 includes a rear portion protruding rearward from the rear end face of the rotor core 32. The rotor shaft 33 includes a front portion protruding frontward from the front end face of the rotor core 32. The rotor magnet 34A is fixed to the rotor core 32. The rotor magnet 34A in the embodiment surrounds the rotor core 32. The sensor magnet 34B is fixed to the rotor core 32. The sensor magnet 34B in the embodiment is located on the front end face of the rotor core 32.

The left motor compartment and the right motor compartment are fastened together with the multiple screws 2S. As shown in FIG. 6, all the screws 2S fastening the left motor compartment and the right motor compartment together are located frontward from the rotor core 32.

A sensor board 35 is attached to the front insulator 30. The sensor board 35 is fastened to the front insulator 30 with a screw 30S. The sensor board 35 includes an annular circuit board and a rotation detector supported on the circuit board. The sensor board 35 at least partially faces the front end face of the sensor magnet 34B. The rotation detector detects the position of the sensor magnet 34B to detect the position of the rotor 27 in the rotation direction.

The rotor 27 has its rear portion supported by the rear rotor bearing 37. The rotor 27 has its front portion supported by the front rotor bearing 38. The rear rotor bearing 37 in the embodiment supports the rear end of the rotor shaft 33. The front rotor bearing 38 supports the front end of the rotor shaft 33. The rotor shaft 33 has its rear end rotatably supported by the rear rotor bearing 37. The rotor shaft 33 has its front end rotatably supported by the front rotor bearing 38. The rear rotor bearing 37 is held by the rear cover 3. The front rotor bearing 38 is held by the bearing box 24.

The rotor shaft 33 has the front end located in the internal space of the hammer case 4 through an opening in the rear annular portion 24A of the bearing box 24.

A pinion gear 41 is fixed to the front end of the rotor shaft 33. The pinion gear 41 is connected to at least a part of the reducer 7. The rotor shaft 33 is connected to the reducer 7 with the pinion gear 41.

The reducer 7 connects the rotor shaft 33 and the spindle 8 together. The rotor 27 drives gears in the reducer 7. The reducer 7 transmits rotation of the rotor 27 to the spindle 8. The reducer 7 rotates the spindle 8 at a lower rotational speed than the rotor shaft 33. The reducer 7 is located frontward from the stator 26. The reducer 7 includes a planetary gear assembly.

The reducer 7 includes multiple planetary gears 42 and an internal gear 43. The multiple planetary gears 42 surround the pinion gear 41. The internal gear 43 surrounds the multiple planetary gears 42. The pinion gear 41, the planetary gears 42, and the internal gear 43 are accommodated in the hammer case 4. Each planetary gear 42 meshes with the pinion gear 41. The planetary gears 42 are rotatably supported by the spindle 8 with a pin 42P. The spindle 8 is rotated by the planetary gears 42. The internal gear 43 includes internal teeth that mesh with the planetary gears 42.

The internal gear 43 is fixed to the larger cylinder 4A in the hammer case 4. The internal gear 43 is constantly nonrotatable relative to the hammer case 4.

When the rotor shaft 33 rotates as driven by the motor 6, the pinion gear 41 rotates, and the planetary gears 42 revolve about the pinion gear 41. The planetary gears 42 revolve while meshing with the internal teeth on the internal gear 43. The revolving planetary gears 42 rotate the spindle 8 connected to the planetary gears 42 with the pin 42P at a lower rotational speed than the rotor shaft 33.

The spindle 8 is rotated about the rotation axis AX by the motor 6. The spindle 8 is rotated by the rotor 27. The spindle 8 rotates with a rotational force from the rotor 27 transmitted through the reducer 7. The spindle 8 transmits a rotational force from the motor 6 to the anvil 10 with balls 48 and a hammer 47 in between. The spindle 8 is at least partially located frontward from the motor 6. The spindle 8 is located frontward from the stator 26. The spindle 8 is at least partially located frontward from the rotor 27. The spindle 8 is at least partially located frontward from the reducer 7. The spindle 8 is at least partially located rearward from the anvil 10.

The spindle 8 includes a spindle shaft 8A, a first flange 8B, a second flange 8C, a joint 8D, and a spindle protrusion 8F.

The spindle shaft 8A is a rod elongated in the front-rear direction. The spindle shaft 8A has the central axis aligned with the rotation axis AX. The first flange 8B extends radially outward from the rear end of the outer circumferential surface of the spindle shaft 8A. The second flange 8C is located rearward from the first flange 8B. The second flange 8C is annular. The joint 8D connects a portion of the first flange 8B to a portion of the second flange 8C. The spindle protrusion 8F protrudes frontward from the front end of the spindle shaft 8A. The first flange 8B supports the front end of the pin 42P. The second flange 8C supports the rear end of the pin 42P. The planetary gears 42 are located between the first flange 8B and the second flange 8C. The planetary gears 42 are rotatably supported by the first flange 8B and the second flange 8C with the pin 42P. The spindle bearing 44 is located inside a cylindrical portion of the spindle 8 protruding rearward from the rear surface of the second flange 8C. The spindle bearing 44 holds the cylindrical portion of the spindle 8. The spindle bearing 44 is held by the bearing box 24.

The striker 9 is driven by the motor 6. A rotational force from the motor 6 is transmitted to the striker 9 through the reducer 7 and the spindle 8. The striker 9 strikes the anvil 10 in the rotation direction in response to a rotational force of the spindle 8 rotated by the motor 6. The striker 9 includes the hammer 47, two balls 48, a coil spring 49, and a washer 50. The striker 9 including the hammer 47, the balls 48, the coil spring 49, and the washer 50 is accommodated in the larger cylinder 4A in the hammer case 4.

The hammer 47 is located frontward from the reducer 7. The hammer 47 surrounds the spindle 8. The hammer 47 surrounds the spindle shaft 8A. The hammer 47 is held by the spindle shaft 8A. The balls 48 are located between the spindle 8 and the hammer 47.

The hammer 47 includes a body 47A, an outer cylinder 47B, an inner cylinder 47C, and two hammer projections 47D. The body 47A surrounds the spindle shaft 8A. The body 47A is annular. The outer cylinder 47B and the inner cylinder 47C both protrude rearward from the body 47A. The outer cylinder 47B is located radially outside the inner cylinder 47C. A recess 47E is defined by the rear surface of the body 47A, the inner circumferential surface of the outer cylinder 47B, and the outer circumferential surface of the inner cylinder 47C. The recess 47E is recessed frontward from the rear end of the hammer 47. The recess 47E is annular. The spindle shaft 8A is located radially inward from the body 47A and the inner cylinder 47C. The hammer projections 47D protrude frontward from the body 47A.

The hammer 47 is rotated by the motor 6. A rotational force from the motor 6 is transmitted to the hammer 47 through the reducer 7 and the spindle 8. The hammer 47 is rotatable together with the spindle 8 in response to a rotational force of the spindle 8 rotated by the motor 6. The rotation axis of the hammer 47 and the rotation axis of the spindle 8 are aligned with the rotation axis AX of the motor 6. The hammer 47 rotates about the rotation axis AX.

The washer 50 is received in the recess 47E. The washer 50 is supported by the hammer 47 with multiple balls 54 in between. The balls 54 are located frontward from the washer 50. The balls 54 are located between the rear surface of the body 47A and the front surface of the washer 50.

The coil spring 49 surrounds the spindle shaft 8A. The coil spring 49 has the rear end supported by the first flange 8B. The coil spring 49 has the front end received in the recess 47E and supported by the washer 50. The coil spring 49 constantly generates an elastic force for moving the hammer 47 forward.

The balls 48 are formed from a metal such as steel. The balls 48 are located between the spindle shaft 8A and the body 47A. The spindle shaft 8A has spindle grooves 8G. The spindle grooves 8G receive at least parts of the balls 48. The spindle grooves 8G are located on the outer circumferential surface of the spindle shaft 8A. The hammer 47 has hammer grooves 47G. The hammer grooves 47G receive at least parts of the balls 48. The hammer grooves 47G are located on the inner circumferential surfaces of the body 47A and the inner cylinder 47C.

The spindle shaft 8A has two spindle grooves 8G on its outer circumferential surface. The body 47A and the inner cylinder 47C have two hammer grooves 47G on their inner circumference surfaces. A first ball 48 is located between a first spindle groove 8G and a first hammer groove 47G. A second ball 48 is located between a second spindle groove 8G and a second hammer groove 47G. The balls 48 roll along the spindle grooves 8G and the hammer grooves 47G. The hammer 47 is movable together with the balls 48. The spindle 8 and the hammer 47 are movable relative to each other in the axial direction and in the rotation direction within a movable range defined by the spindle grooves 8G and the hammer grooves 47G.

The anvil 10 is located frontward from the motor 6. The anvil 10 is an output unit in the power tool 1 that rotates in response to a rotational force of the rotor 27. The anvil 10 is at least partially located frontward from the spindle 8. The anvil 10 is at least partially located frontward from the hammer 47. The anvil 10 is struck by the hammer 47 in the rotation direction.

The anvil 10 includes an anvil shaft 10A and two anvil projections 10B. The anvil shaft 10A is a rod elongated in the front-rear direction. The anvil shaft 10A has the central axis aligned with the rotation axis AX. The anvil projections 10B are located at the rear end of the anvil shaft 10A. The anvil projections 10B protrude radially outward from the rear end of the anvil shaft 10A.

The anvil 10 has a tool hole 10C in its front end face. The anvil 10 has an anvil recess 10D on its rear end face. The tool hole 10C extends rearward from the front end face of the anvil shaft 10A. The tool hole 10C receives a tip tool. The tip tool is attached to the anvil 10. The anvil recess 10D is recessed frontward from the rear end face of the anvil 10. The anvil recess 10D receives the spindle protrusion 8F.

The anvil 10 is rotatably supported by anvil bearings 46. The rotation axis of the anvil 10, the rotation axis of the hammer 47, and the rotation axis of the spindle 8 are aligned with the rotation axis AX of the motor 6. The anvil 10 rotates about the rotation axis AX. The anvil bearings 46 surround the anvil shaft 10A. An O-ring 45 is located between each anvil bearing 46 and the anvil shaft 10A. The anvil bearings 46 are located inside the smaller cylinder 4B in the hammer case 4. The anvil bearings 46 are held by the smaller cylinder 4B in the hammer case 4. The hammer case 4 supports the anvil 10 with the anvil bearings 46. The anvil bearings 46 support a front portion of the anvil shaft 10A in a rotatable manner. In the embodiment, two anvil bearings 46 are arranged in the front-rear direction.

A washer 56 and a support 57 are located frontward from the anvil projections 10B. The support 57 is in contact with the rear surface of the connecting portion 4C and the rear surfaces of outer rings in the anvil bearings 46. The support 57 is annular. The support 57 reduces the likelihood of the anvil bearings 46 slipping rearward from the smaller cylinder 4B. The support 57 reduces contact between the front surfaces of the anvil projections 10B and the hammer case 4. The washer 56 supports the support 57 from the rear. The washer 56 is received in a groove on the inner circumferential surface of the larger cylinder 4A.

The hammer projections 47D can come in contact with the anvil projections 10B. When the motor 6 is driven, with the hammer projections 47D and the anvil projections 10B in contact with each other, the anvil 10 rotates together with the hammer 47 and the spindle 8.

The anvil 10 is struck by the hammer 47 in the rotation direction. When, for example, the anvil 10 receives a higher load in a screwing operation, the anvil 10 may fail to rotate with an urging force from the coil spring 49 alone. This stops the rotation of the anvil 10 and the hammer 47. The spindle 8 and the hammer 47 are movable relative to each other in the axial direction and in the circumferential direction through the balls 48 in between. Although the hammer 47 stops rotating, the spindle 8 continues to rotate with power generated by the motor 6. When the hammer 47 stops rotating and the spindle 8 rotates, the balls 48 move backward as being guided along the spindle grooves 8G and the hammer grooves 47G. The hammer 47 receives a force from the balls 48 to move backward with the balls 48. In other words, the hammer 47 moves backward when the anvil 10 stops rotating and the spindle 8 rotates. Thus, the hammer projections 47D come out of contact with the anvil projections 10B.

The coil spring 49 constantly generates an elastic force for moving the hammer 47 forward. The hammer 47 that has moved backward moves forward under the elastic force from the coil spring 49. When moving forward, the hammer 47 receives a force in the rotation direction from the balls 48. In other words, the hammer 47 moves forward while rotating. The hammer 47 then comes in contact with the anvil projections 10B while rotating. Thus, the anvil projections 10B are struck by the hammer projections 47D in the rotation direction. The anvil 10 receives power from the motor 6 and an inertial force from the hammer 47. The anvil thus rotates with high torque about the rotation axis AX.

The tool holder 11 surrounds a front portion of the anvil 10. The tool holder 11 holds the tip tool received in the tool hole 10C in the anvil 10. The tip tool is attachable to and detachable from the tool holder 11.

The tool holder 11 includes two balls 71, a leaf spring 72, a sleeve 73, a coil spring 74, and a positioner 75.

The anvil 10 has support recesses 76 for supporting the balls 71. The support recesses 76 are located on the outer surface of the anvil shaft 10A. In the embodiment, the anvil shaft 10A has two support recesses 76.

The balls 71 are supported on the anvil 10 in a movable manner. The balls 71 are received in the support recesses 76. One ball 71 is received in one support recess 76.

The anvil shaft 10A has a through-hole connecting the inner surfaces of the support recesses 76 and the inner surface of the tool hole 10C. Each ball 71 has a smaller diameter than the through-hole. The balls 71 supported in the support recesses 76 are at least partially received in the tool hole 10C. The balls 71 fasten the tip tool received in the tool hole 10C. Each ball 71 is movable between an engagement position and a release position. At the engagement position, the balls 71 fasten the tip tool. At the release position, the balls 71 unfasten the tip tool.

The leaf spring 72 generates an elastic force for moving the balls 71 to the engagement position. The leaf spring 72 surrounds the anvil shaft 10A. The leaf spring 72 generates an elastic force for moving the balls 71 forward.

The sleeve 73 is cylindrical. The sleeve 73 surrounds the anvil shaft 10A. The sleeve 73 is movable in the axial direction around the anvil shaft 10A. The sleeve 73 restricts the balls 71 at the engagement position from coming out of the engagement position. The sleeve 73 moves in the axial direction to permit the ball 71 to be movable from the engagement position to the release position.

The sleeve 73 is movable between a movement-restricting position and a movement-permitting position around the anvil shaft 10A. At the movement-restricting position, the sleeve 73 restricts radially outward movement of the balls 71. At the movement-permitting position, the sleeve 73 permits radially outward movement of the balls 71.

The sleeve 73 at the movement-restricting position restricts the balls 71 at the engagement position from moving radially outward. In other words, the sleeve 73 at the movement-restricting position restricts the balls 71 at the engagement position from coming out of the engagement position. The sleeve 73 at the movement-restricting position causes the tip tool to be fastened with the ball 71.

The sleeve 73 moves to the movement-permitting position to permit the balls 71 at the engagement position to move radially outward. The sleeve 73 moves to the movement-permitting position to permit the balls 71 to move from the engagement position to the release position. In other words, the sleeve 73 at the movement-permitting position permits the balls 71 to come out of the engagement position. The sleeve 73 at the movement-permitting position permits the tip tool, fastened with the ball 71, to be unfastened.

The coil spring 74 generates an elastic force for moving the sleeve 73 to the movement-restricting position. The coil spring 74 surrounds the anvil shaft 10A. The movement-restricting position is defined rearward from the movement-permitting position. The coil spring 74 generates an elastic force for moving the sleeve 73 backward.

The positioner 75 is annular and is fixed on the outer surface of the anvil shaft 10A. The positioner 75 is fixed to face the rear end of the sleeve 73. The positioner 75 positions the sleeve 73 at the movement-restricting position. The sleeve 73 under an elastic force from the coil spring 74 for moving backward comes in contact with the positioner 75 and is positioned at the movement-restricting position.

The fan 12 is located rearward from the stator 26. The fan 12 generates an airflow for cooling the motor 6. The fan 12 is fastened to at least a part of the rotor 27. The fan 12 is fastened to the rear portion of the rotor shaft 33 with a bush 12A. The fan 12 is located between the rear rotor bearing 37 and the stator 26. The fan 12 rotates as the rotor 27 rotates. As the rotor shaft 33 rotates, the fan 12 rotates together with the rotor shaft 33. Thus, air outside the housing 2 flows into the internal space of the housing 2 through the inlets 19 and cools the motor 6. As the fan 12 rotates, the air passing through the internal space of the housing 2 flows out of the housing 2 through the outlets 20.

The battery mount 13 is located in a lower portion of the battery holder 23. The battery mount 13 is connected to the battery pack 25. The battery pack 25 is attached to the battery mount 13 in a detachable manner. The battery pack 25 is placed onto the battery mount 13 from the front of the battery holder 23 and is thus attached to the battery mount 13. The battery pack 25 is pulled forward along the battery mount 13 and is thus detached from the battery mount 13. The battery pack 25 includes a secondary battery. The battery pack 25 in the embodiment includes a rechargeable lithium-ion battery. The battery pack 25 is attached to the battery mount 13 to power the power tool 1. The motor 6 is driven by power supplied from the battery pack 25.

The trigger lever 14 is located on the grip 22. The trigger lever 14 is operable by the operator to activate the motor 6. The trigger lever 14 is operable to switch the motor 6 between the driving state and the stopped state.

The forward-reverse switch lever 15 is located above the grip 22. The forward-reverse switch lever 15 is operable by the operator. The forward-reverse switch lever 15 is operable to switch the rotation direction of the motor 6 between forward and reverse. This switches the rotation direction of the spindle 8.

The mode switch hand button 16 is located above the trigger lever 14. The mode switch hand button 16 is operable by the operator. A circuit board 16A and a switch 16B are located behind the mode switch hand button 16. The switch 16B is mounted on the front surface of the circuit board 16A. The mode switch hand button 16 is located in front of the switch 16B. In response to the mode switch hand button 16 being pressed backward, the switch 16B operates to output an operation signal from the circuit board 16A. The operation signal output from the circuit board 16A is transmitted to a controller (not shown). The controller switches the control mode of the motor 6 in response to the operation signal output from the circuit board 16A.

The light assembly 18 emits illumination light. The light assembly 18 illuminates the anvil 10 and an area around the anvil 10 with illumination light. The light assembly 18 illuminates an area ahead of the anvil 10 with illumination light. The light assembly 18 also illuminates the tip tool attached to the anvil 10 and an area around the tip tool with illumination light. The light assembly 18 in the embodiment surrounds the smaller cylinder 4B. The light assembly 18 includes a circuit board 18A, a light emitter 18B, and an optical member 18C. The light emitter 18B is supported on the circuit board 18A. Light emitted from the light emitter 18B passes through the optical member 18C. The optical member 18C is annular.

The light cover 52 protects the light assembly 18. The light cover 52 reduces contact between the light assembly 18 and objects around the light assembly 18. The light cover 52 surrounds the optical member 18C.

### Rear Cover

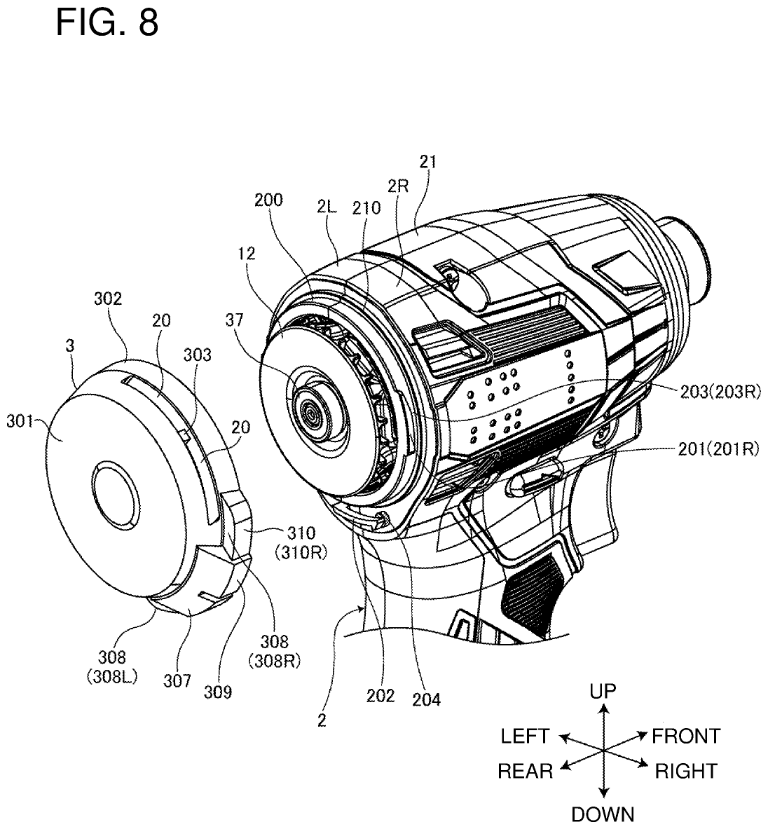

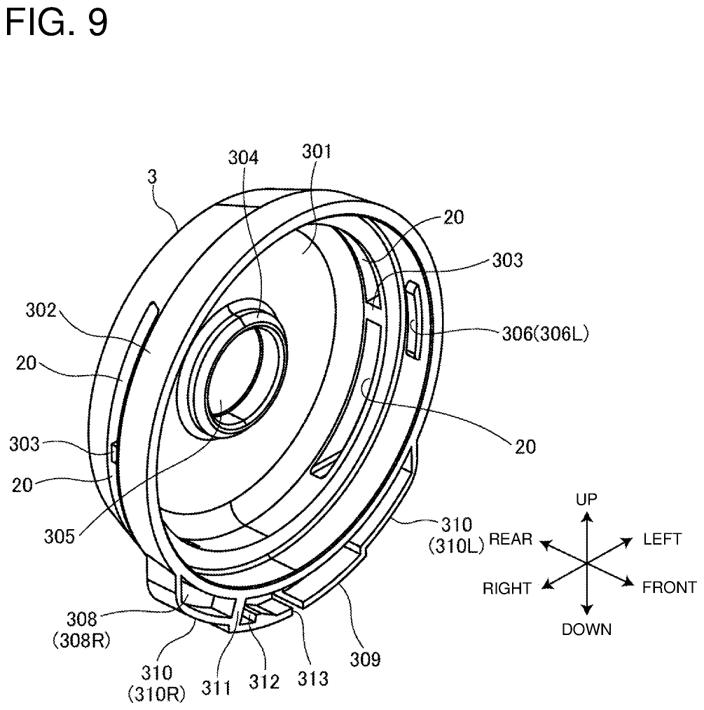

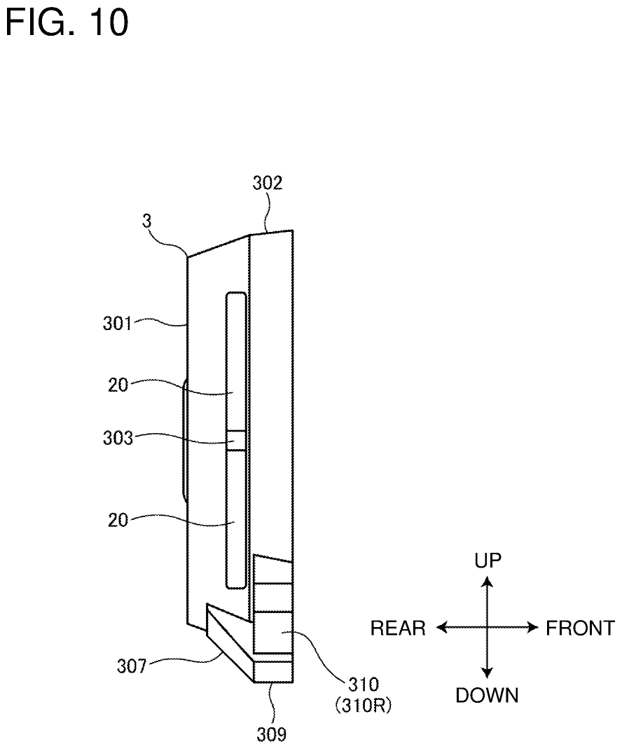

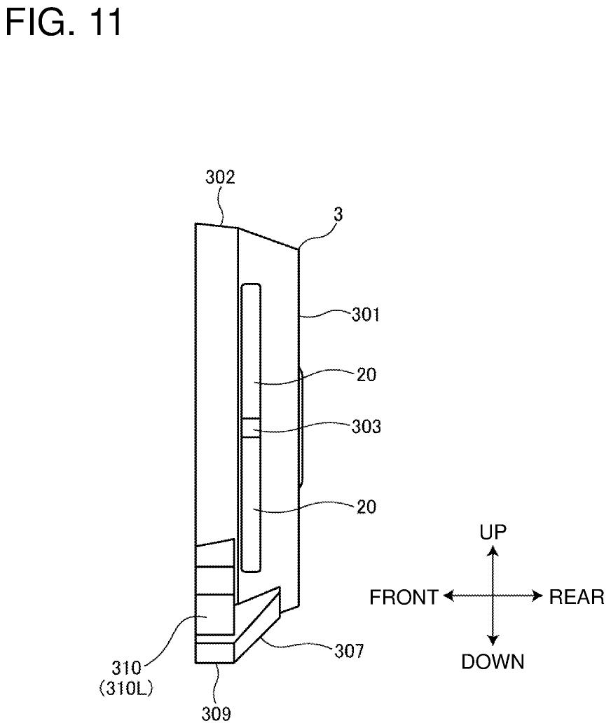

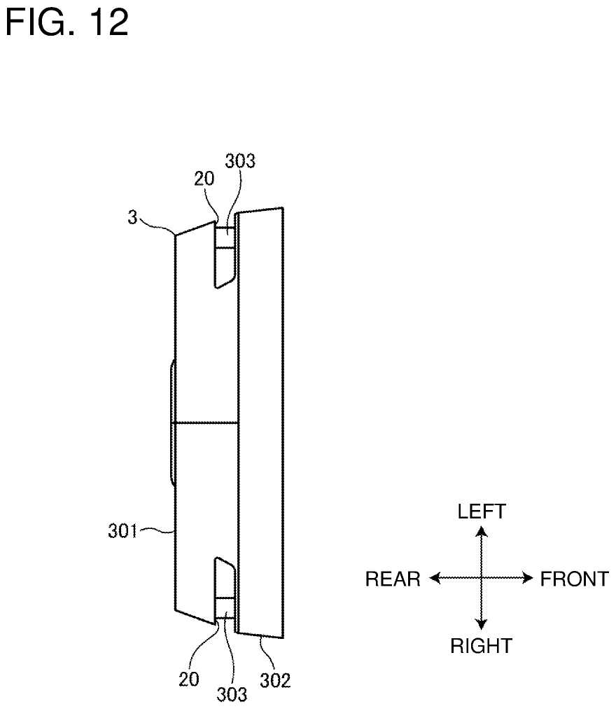

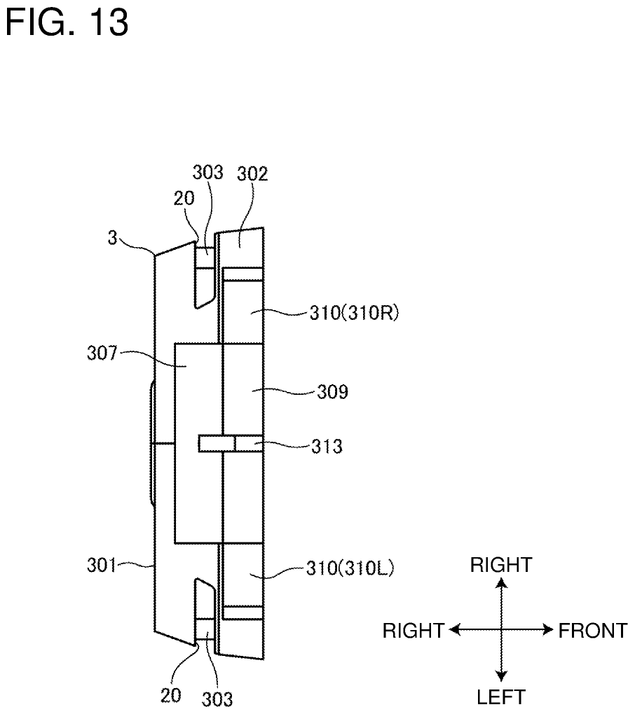

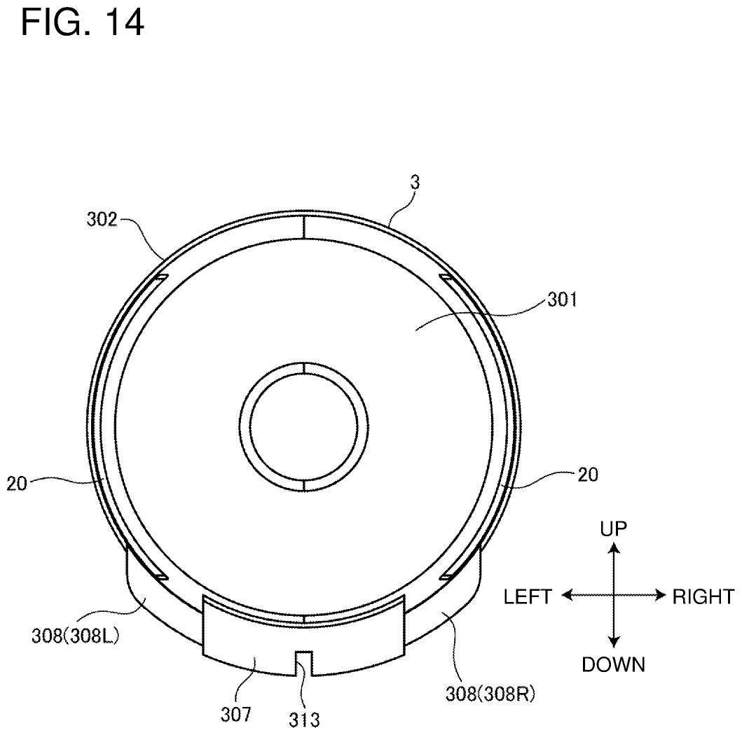

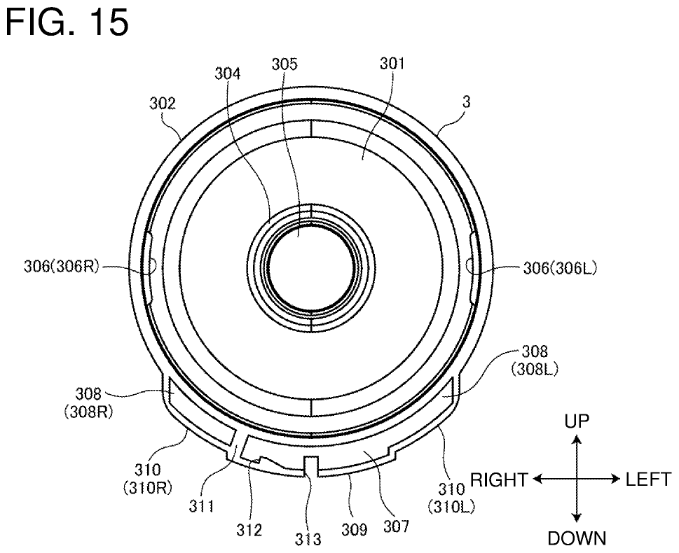

FIG. 8 is an exploded perspective view of the upper portion of the power tool 1 according to the present embodiment as viewed from the rear. FIG. 9 is a front perspective view of the rear cover 3. FIG. 10 is a right side view of the rear cover 3. FIG. 11 is a left side view of the rear cover 3. FIG. 12 is a top view of the rear cover 3. FIG. 13 is a bottom view of the rear cover 3. FIG. 14 is a rear view of the rear cover 3. FIG. 15 is a front view of the rear cover 3.

The rear cover 3 is fastened to the rear of the motor compartment 21 without using screws. The rear cover 3 is attachable to and detachable from the motor compartment 21. The rear cover 3 includes a cover plate 301, a cover cylinder 302, pillars 303, a protrusion 304, a receiving portion 305, cover tabs 306, a middle rear plate 307, side rear plates 308, a middle lower plate 309, side lower plates 310, a rib 311, an engagement portion 312, and a hole 313.

The cover plate 301 is a disk. The cover plate 301 is located rearward from the fan 12. The cover cylinder 302 protrudes frontward from the rim of the cover plate 301. The outlets 20 are located in right and left portions of the cover cylinder 302. The outlets 20 are slits elongated in the vertical direction. The outlets 20 are elongated in the vertical direction in the left and right side surfaces of the rear cover 3. Each pillar 303 is located in the middle of the corresponding outlet 20 in the vertical direction.

The protrusion 304 is located at the center of the front surface of the cover plate 301. The protrusion 304 is cylindrical. The protrusion 304 protrudes frontward from the front surface of the cover plate 301. The protrusion 304 defines the receiving portion 305 inside. The rear rotor bearing 37 is received in the receiving portion 305. The rear rotor bearing 37 has its outer circumference supported by the protrusion 304. The rear rotor bearing 37 has its rear portion supported by the cover plate 301.

The cover tabs 306 are located on the inner circumferential surface of the cover cylinder 302. The cover tabs 306 protrude radially inward from the inner circumferential surface of the cover cylinder 302. Multiple (two in the present embodiment) cover tabs 306 are located at intervals in the circumferential direction. The cover tabs 306 include a cover tab 306L and a cover tab 306R. The cover tab 306L is located leftward from the center of the cover plate 301. The cover tab 306R is located rightward from the center of the cover plate 301.

The middle rear plate 307 and the side rear plates 308 protrude downward from a lower portion of the cover cylinder 302. The middle rear plate 307 slopes downward toward the front. The side rear plates 308 are located frontward from the middle rear plate 307. The side rear plates 308 are located on the left and right of the middle rear plate 307. The side rear plates 308 include a side rear plate 308L and a side rear plate 308R. The side rear plate 308L is located leftward from the middle rear plate 307. The side rear plate 308R is located rightward from the middle rear plate 307.

The middle lower plate 309 and the side lower plates 310 are located radially outward from the cover cylinder 302. In the radial direction, the distance from the center of the cover plate 301 to the middle lower plate 309 is longer than the distance from the center of the cover plate 301 to each side lower plate 310. The middle lower plate 309 is connected to the lower end of the middle rear plate 307. The middle lower plate 309 extends frontward from the lower end of the middle rear plate 307. The side lower plates 310 are located on the left and right of the middle lower plate 309. The side lower plates 310 include a side lower plate 310L and a side lower plate 310R. The side lower plate 310L is located leftward from the middle lower plate 309. The side lower plate 310R is located rightward from the middle lower plate 309. The side lower plate 310L is partially connected to the lower end of the side rear plate 308L. The side lower plate 310L is partially connected to the left end of the side rear plate 308L. The side lower plate 310L has its left end connected to the outer circumferential surface of the cover cylinder 302. The side lower plate 310L extends frontward from the peripheral edge of the side rear plate 308L. The side lower plate 310R is partially connected to the lower end of the side rear plate 308R. The side lower plate 310R is partially connected to the right end of the side rear plate 308R. The side lower plate 310R has its right end connected to the outer circumferential surface of the cover cylinder 302. The side lower plate 310R extends frontward from the peripheral edge of the side rear plate 308R.

The rib 311 protrudes radially outward from the outer circumferential surface of the cover cylinder 302. The rib 311 is located rightward from the center of the cover plate 301 in the lateral direction. The rib 311 has its radially inward end connected to the outer circumferential surface of the cover cylinder 302. The rib 311 has its radially outer end connected to the right end of the upper surface of the middle lower plate 309. The rib 311 may have its radially outer end connected to the left end of the upper surface of the side lower plate 310R. The rib 311 has its rear surface connected to the front surface of the middle rear plate 307. The rib 311 may have its rear surface connected to the front surface of the side rear plate 308R.

The engagement portion 312 protrudes radially inward from the upper surface of the middle lower plate 309. The engagement portion 312 is located rightward from the center of the cover plate 301 in the lateral direction.

The hole 313 is located in the middle lower plate 309. The hole 313 extends through the middle lower plate 309 from the upper surface to the lower surface. The hole 313 is aligned with the center of the cover plate 301 in the lateral direction. The hole 313 is a cutout in the middle rear plate 307.

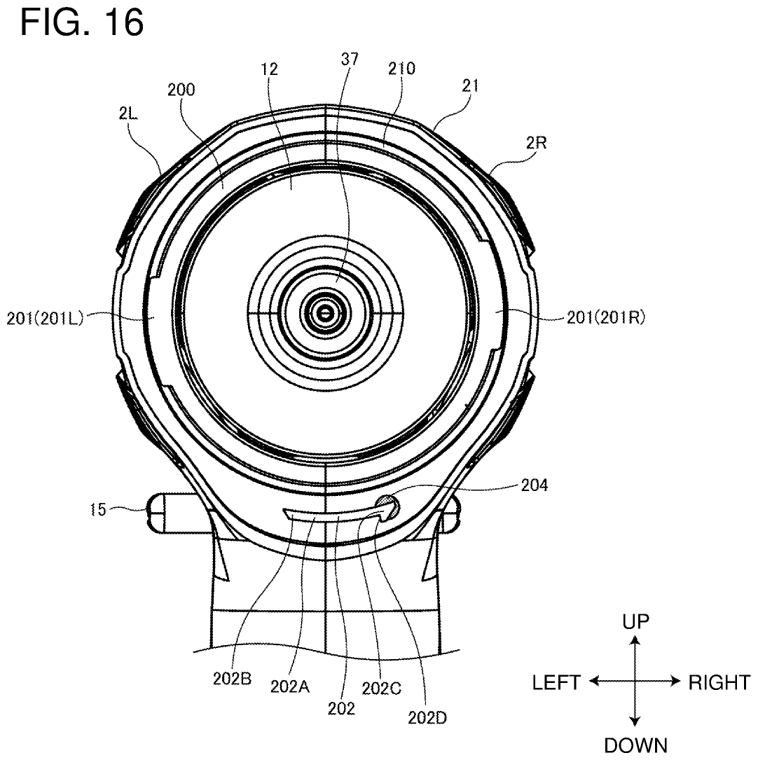

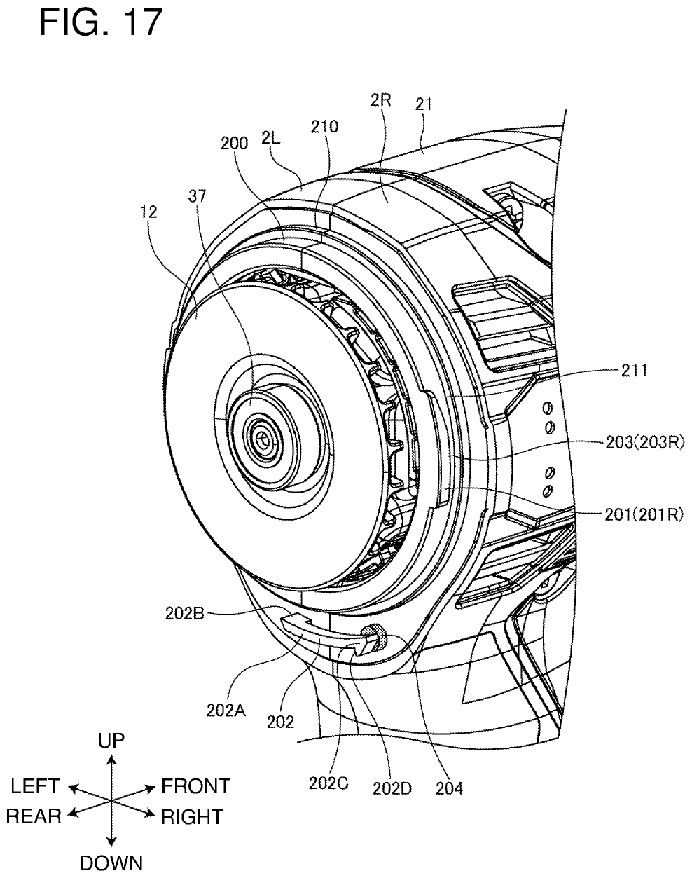

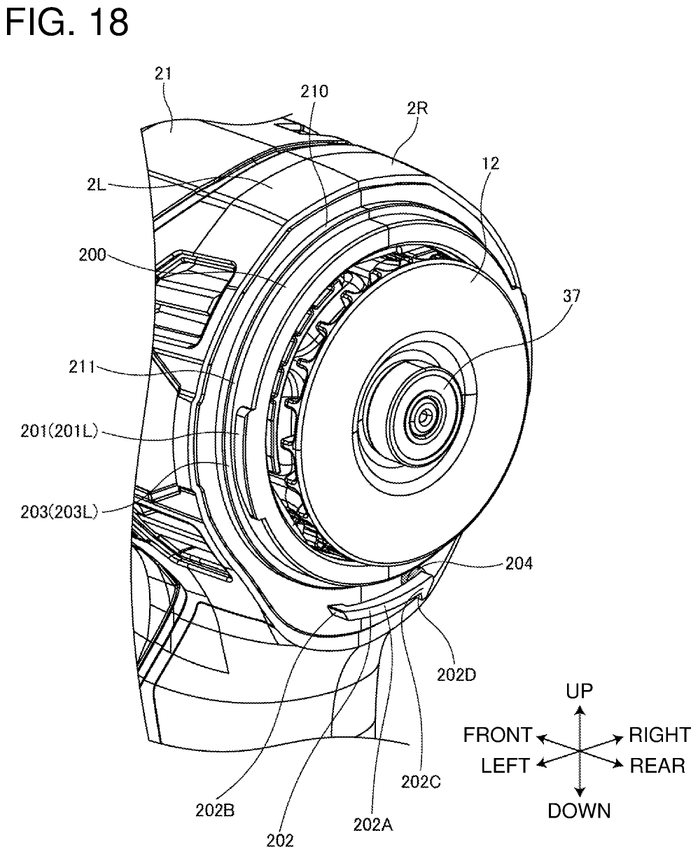

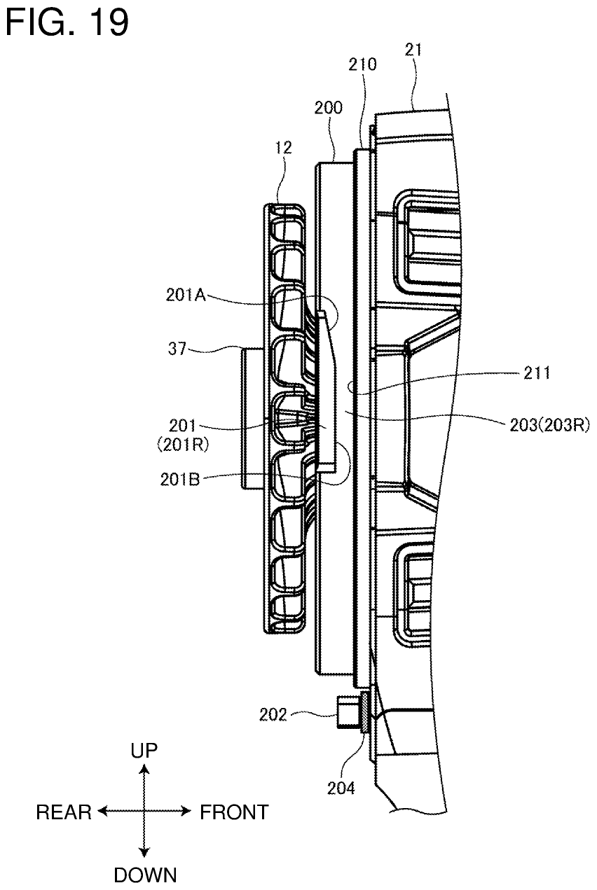

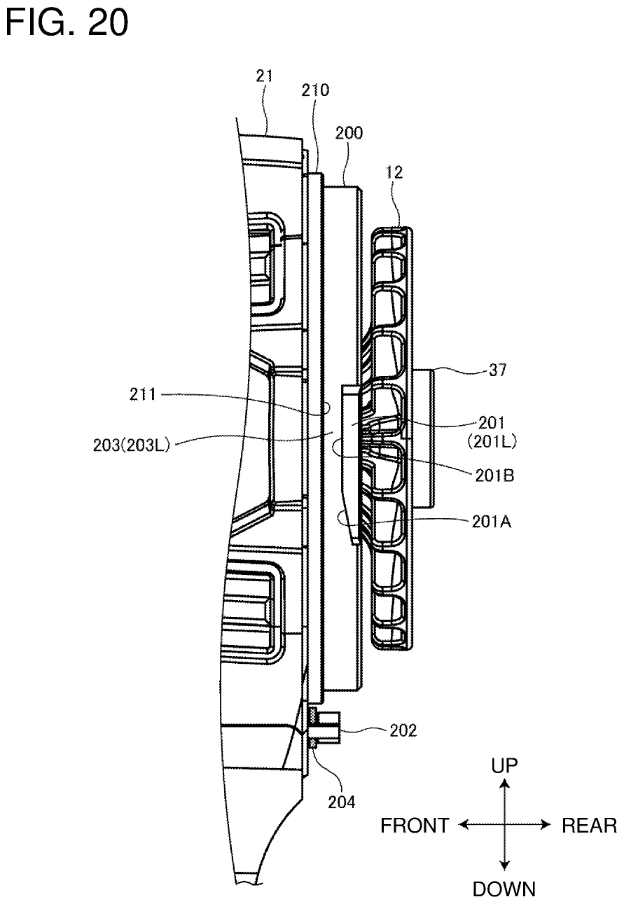

FIG. 16 is a rear view of an upper rear portion of the power tool 1 according to the present embodiment without the rear cover 3. FIG. 17 is a perspective view of the upper rear portion of the power tool 1 without the rear cover 3 as viewed from the right rear. FIG. 18 is a perspective view of the upper rear portion of the power tool 1 without the rear cover 3 as viewed from the left rear. FIG. 19 is a right side view of the upper rear portion of the power tool 1 without the rear cover 3. FIG. 20 is a left side view of the upper rear portion of the power tool 1 without the rear cover 3.

The motor compartment 21 includes a cylindrical portion 210, a housing cylinder 200, housing tabs 201, a hook 202, and an elastic member 204.

The cylindrical portion 210 is located at the rear of the motor compartment 21. The cylindrical portion 210 has a support surface 211 facing rearward. The support surface 211 is substantially flat. The support surface 211 is orthogonal to an axis parallel to the rotation axis AX. The support surface 211 surrounds the rotation axis AX. The support surface 211 is annular.

The housing cylinder 200 protrudes rearward from the support surface 211. The housing cylinder 200 defines the opening at the rear end of the motor compartment 21. The opening at the rear end of the motor compartment 21 is defined inside the housing cylinder 200. The rear cover 3 covers the opening defined by the housing cylinder 200. The housing cylinder 200 is substantially cylindrical. The support surface 211 surrounds the front end of the cylindrical portion 210.

The housing tabs 201 are located on the outer circumferential surface of the housing cylinder 200. The housing tabs 201 protrude radially outward from the outer circumferential surface of the housing cylinder 200. Multiple (two in the present embodiment) housing tabs 201 are located at intervals in the circumferential direction. The housing tabs 201 include a housing tab 201L and a housing tab 201R. The housing tab 201L is located leftward from the rotation axis AX. The housing tab 201R is located rightward from the rotation axis AX.

Each housing tab 201 has a slope 201A and a front surface 201B. The slope 201A faces substantially frontward. The slope 201A slopes frontward in the first circumferential direction. The front surface 201B faces frontward. The front surface 201B is orthogonal to an axis parallel to the rotation axis AX. As shown in FIG. 19, the housing tab 201R has the slope 201A above the front surface 201B. As shown in FIG. 20, the housing tab 201L has the slope 201A below the front surface 201B.

The front surface 201B faces the support surface 211 with a space in between. Receiving portions 203 are defined between the front surface 201B and the support surface 211. The receiving portions 203 include a receiving portion 203R and a receiving portion 203L. The receiving portion 203R is defined between the front surface 201B of the housing tab 201R and the support surface 211. The receiving portion 203L is defined between the front surface 201B of the housing tab 201L and the support surface 211.

The hook 202 is located radially outward from the housing cylinder 200. The hook 202 is located below the housing cylinder 200. The hook 202 includes an arm 202A and a hook portion 202D. The arm 202A is an arc extending in the circumferential direction. The arm 202A has a basal end 202B fixed to the motor compartment 21. The hook portion 202D is located at a distal end 202C of the arm 202A. The arm 202A has the basal end 202B fixed to the rear surface of the left housing 2L. The hook portion 202D is not fixed to the motor compartment 21. The hook portion 202D faces the rear surface of the right housing 2R. The arm 202A elastically deforms to allow radial movement of the hook portion 202D.

The elastic member 204 is supported on the motor compartment 21. The elastic member 204 is cylindrical. The elastic member 204 is formed from, for example, rubber. The right housing 2R has a recess in its rear surface. The elastic member 204 includes a front portion received in the recess. The elastic member 204 has its rear surface facing at least a part of the hook 202. In the embodiment, the elastic member 204 has the rear surface facing the hook portion 202D.

The rear cover 3 is rotated relative to the rear of the motor compartment 21 to fasten the rear cover 3 to the rear of the motor compartment 21. The motor compartment 21 includes guides, front-rear restrictors, and a circumferential restrictor. The guides guide the rear cover 3 in the first circumferential direction and frontward. The front-rear restrictors restrict front-rear movement of the rear cover 3 guided by the guides. The circumferential restrictor restricts circumferential movement of the rear cover 3 being restricted from the front-rear movement.

The guides are located on the housing tabs 201. Each guide includes the slope 201A of the corresponding housing tab 201. The guides in the embodiment guide the cover tabs 306 on the rear cover 3. The cover tabs 306 are guided along the slopes 201A. The rear cover 3 is thus guided in the first circumferential direction and frontward along the guides.

The front-rear restrictors are at least partially located on the housing tabs 201. The front-rear restrictors each include the front surface 201B of the corresponding housing tab 201. The front-rear restrictors each also include the support surface 211 of the cylindrical portion 210. The front surfaces 201B restrict the rearward movement of the rear cover 3. The support surface 211 restricts the frontward movement of the rear cover 3. The front-rear restrictors in the embodiment restrict the front-rear movement of the cover tabs 306. The cover tabs 306 are guided in the first circumferential and frontward along the slopes 201A and then located in the receiving portions 203 between the front surfaces 201B and the support surface 211. Each cover tab 306 has its rear surface in contact with the corresponding front surface 201B. Each cover tab 306 has its front surface in contact with the support surface 211. The cover tabs 306 received in the receiving portions 203 restrict the front-rear movement of the rear cover 3.

The circumferential restrictor is at a position different from the positions of the front-rear restrictors. The circumferential restrictor includes the hook 202. The hook portion 202D of the hook 202 is hooked on the engagement portion 312 on the rear cover 3. The rib 311 on the rear cover 3 is in contact with the distal end of the hook 202 with the hook portion 202D hooked on the engagement portion 312. The hook portion 202D restricts the movement of the rear cover 3 in the second circumferential direction. The hook 202 has its distal end that restricts the movement of the rear cover 3 in the first circumferential direction.

### Fastening of Rear Cover

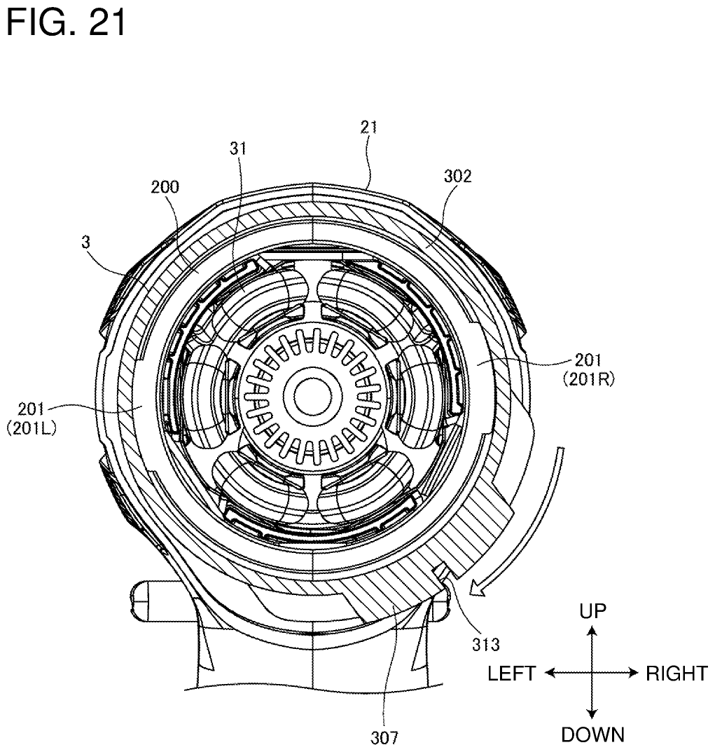

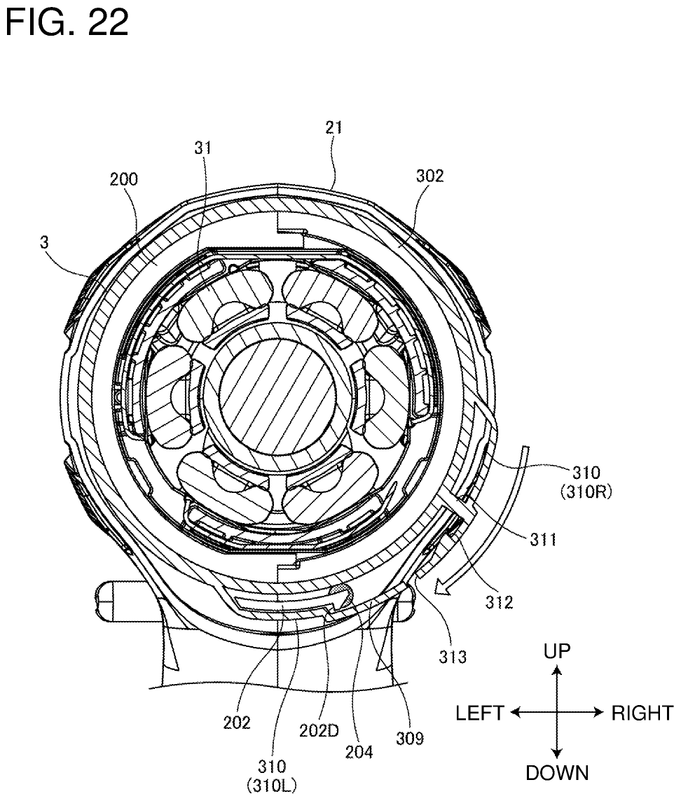

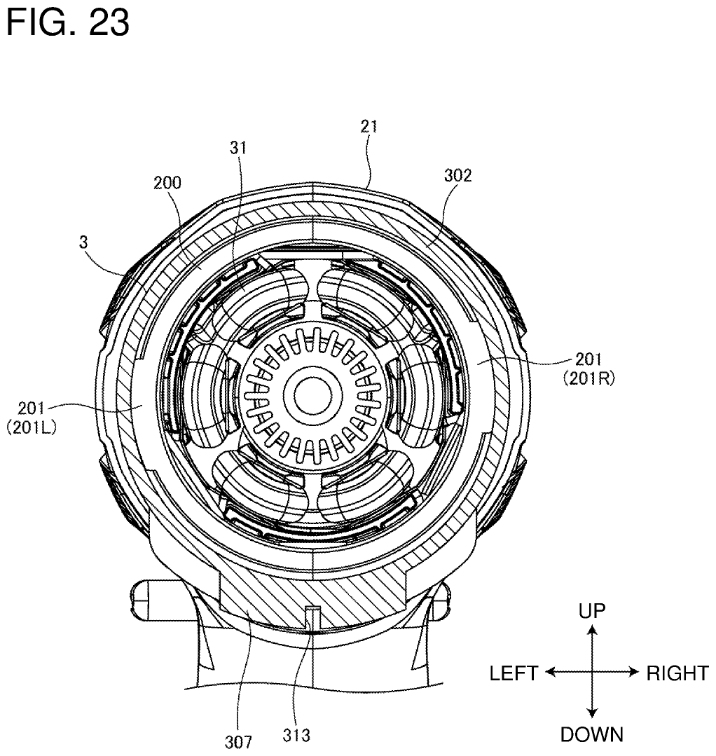

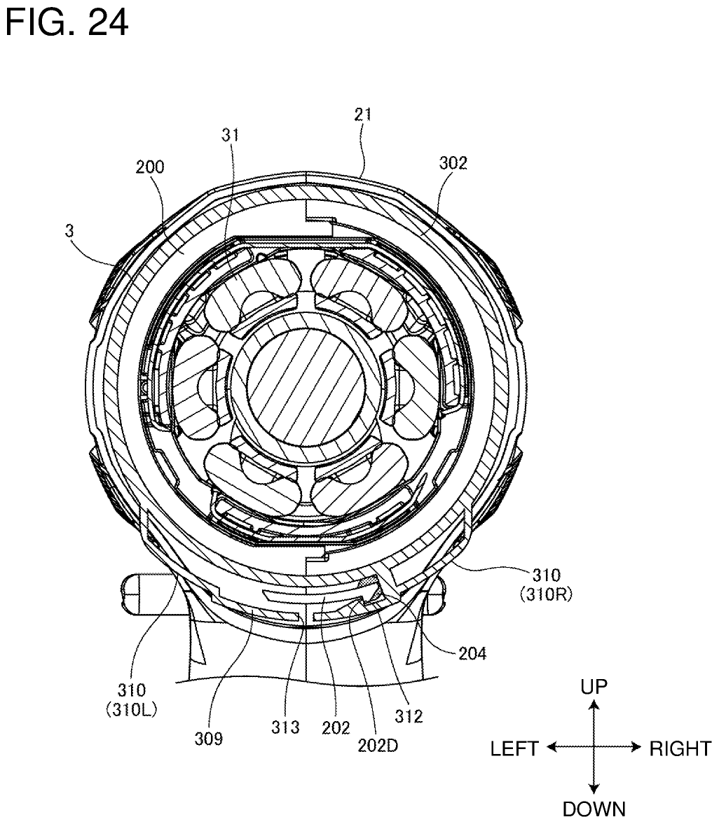

FIGS. 21 to 24 are cross-sectional views of the rear cover 3 in the embodiment, describing its fastening. FIGS. 21 and 23 are cross-sectional views taken along line A-A in FIG. 6 as viewed in the direction indicated by the arrows. FIGS. 22 and 24 are cross-sectional views taken along line B-B in FIG. 6 as viewed in the direction indicated by the arrows.

The left housing 2L including the left motor compartment and the right housing 2R including the right motor compartment are fastened together with the multiple screws 2S. After the left housing 2L including the left motor compartment and the right housing 2R including the right motor compartment are fastened together, the rear cover 3 is fastened to the rear of the left motor compartment and to the rear of the right motor compartment.

To fasten the rear cover 3 to the rear of the motor compartment 21, the cover cylinder 302 is placed on the circumference of the housing cylinder 200 with the cover tab 306L farther than the housing tab 201L in the second circumferential direction and the cover tab 306R farther than the housing tab 201R in the second circumferential direction. The cover cylinder 302 is also placed on the circumference of the housing cylinder 200 with the hook 202 between the cover cylinder 302 and the side lower plate 310L.

The rear cover 3 is then rotated relative to the motor compartment 21 in the first circumferential direction, as indicated by the arrows in FIGS. 21 and 22. The cover tab 306L then comes in contact with the housing tab 201L, and the cover tab 306R comes in contact with the housing tab 201R. As the rear cover 3 is rotated further in the first circumferential direction, the cover tab 306L is guided in the first circumferential and frontward along the slope 201A of the housing tab 201L, and the cover tab 306R is guided in the first circumferential and frontward along the slope 201A of the housing tab 201R. This causes the rear cover 3 rotated in the first circumferential direction to move frontward.

After the cover tabs 306 (306L, 306R) are guided along the slopes 201A, the rear cover 3 is rotated further in the first circumferential direction. The cover tab 306L is then received in the receiving portion 203L between the front surface 201B of the housing tab 201L and the support surface 211, and the cover tab 306R is received in the receiving portion 203R between the front surface 201B of the housing tab 201R and the support surface 211. The rear surface of the cover tab 306L comes in contact with the front surface 201B of the housing tab 201L. The front surface of the cover tab 306L comes in contact with the support surface 211. The rear surface of the cover tab 306R comes in contact with the front surface 201B of the housing tab 201R. The front surface of the cover tab 306R comes in contact with the support surface 211. This restricts the front-rear movement of the cover tabs 306 (306L, 306R). This restricts the front-rear movement of the rear cover 3.

The rear cover 3 includes a portion including the cover tab 306L and located leftward from the left motor compartment. The rear cover 3 includes a portion including the cover tab 306R and located rightward from the right motor compartment. The rear cover 3 is located on the left of the left motor compartment and the right of the right motor compartment, preventing separation between the rear of the left motor compartment and the rear of the right motor compartment.

As shown in FIGS. 23 and 24, the hook portion 202D of the hook 202 is hooked on the engagement portion 312 of the rear cover 3, with the cover tabs 306 received in the receiving portions 203 and the rear cover 3 being restricted from the front-rear movement. The arm 202A in the hook 202 elastically deforms to allow radial movement of the hook portion 202D. During rotation of the rear cover 3, the arm 202A elastically deforms and allows the hook portion 202D to move radially along the upper surface of the middle lower plate 309. The rib 311 comes in contact with the distal end of the hook 202 with the hook portion 202D hooked on the engagement portion 312. The hook portion 202D hooked on the engagement portion 312 restricts the movement of the rear cover 3 in the second circumferential direction. The distal end of the hook 202 in contact with the rib 311 restricts the movement of the rear cover 3 in the first circumferential direction.

The elastic member 204 in a compressed state comes in contact with the cover cylinder 302, the middle lower plate 309, and the rib 311, with the hook portion 202D hooked on the engagement portion 312. In other words, the elastic member 204 fits in a space defined by the cover cylinder 302, the middle lower plate 309, and the rib 311. The elastic member 204 reduces rattling of the rear cover 3. The elastic member 204 pressed against the hook 202 also reduces unintended elastic deformation of the arm 202A. In other words, the elastic member 204 pressed against the hook 202 reduces unintended radial movement of the hook portion 202D. The hook portion 202D is thus less likely to be disengaged from the engagement portion 312.

As described above, the rear cover 3 is simply placed onto the rear of the motor compartment 21 and rotated relative to the rear in the embodiment. This restricts the front-rear movement of the rear cover 3 relative to the motor compartment 21 as well as the movement of the rear cover 3 relative to the motor compartment 21 in the first circumferential direction. The rear cover 3 is fastened to the rear of the motor compartment 21. After the left motor compartment and the right motor compartment are fastened together with the screws 2S, the rear cover 3 is fastened to the left motor compartment and the right motor compartment simply through engagement with the rear of the left motor compartment and the rear of the right motor compartment.

With the rear cover 3 fastened to the rear of the motor compartment 21, the outer circumferential surface of the housing cylinder 200 and the inner circumferential surface of the cover cylinder 302 face each other. The outer circumferential surface of the housing cylinder 200 and the inner circumferential surface of the cover cylinder 302 may be in contact with or apart from each other. With the rear cover 3 fastened to the rear of the motor compartment 21, the cover tabs 306 come in contact with the housing tabs 201. With the rear cover 3 fastened to the rear of the motor compartment 21, the cover cylinder 302 surrounds the housing cylinder 200. With the rear cover 3 fastened to the rear of the motor compartment 21, the hook 202 is located radially outward from the cover cylinder 302. With the rear cover 3 fastened to the rear of the motor compartment 21, the middle lower plate 309 is located radially outward from the hook 202. With the rear cover 3 fastened to the rear of the motor compartment 21, the elastic member 204 is located between the cover cylinder 302 and the middle lower plate 309.

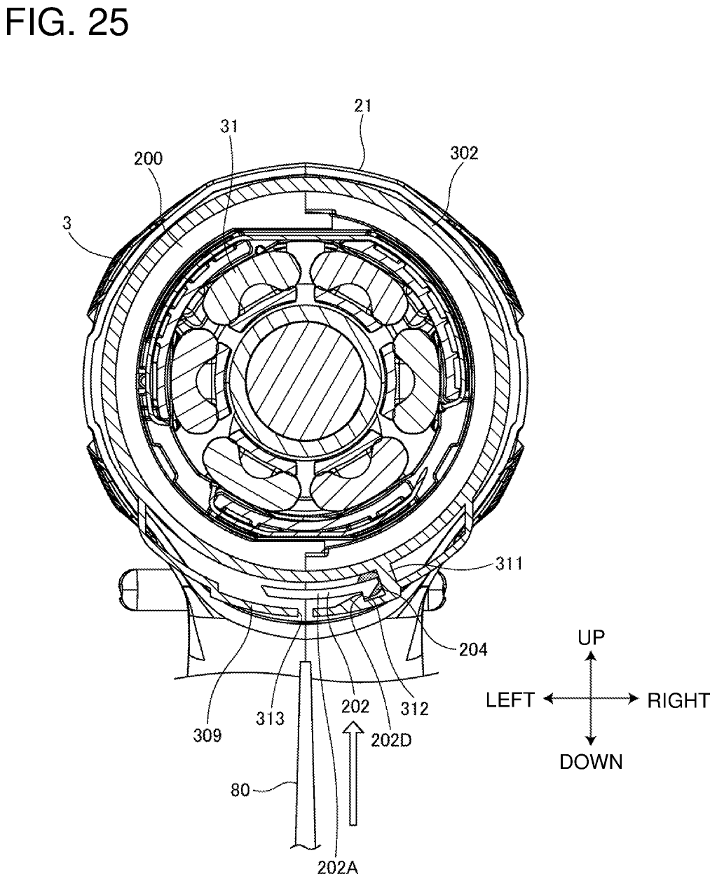

FIG. 25 is a cross-sectional view of the rear cover 3 in the embodiment, describing its unfastening. To remove the rear cover 3 from the motor compartment 21, a tool 80 is inserted into the hole 313 from below the hole 313. The tool 80 is a rod member insertable into the hole 313. The tool 80 inserted in the hole 313 moves the arm 202A upward to disengage the hook portion 202D from the engagement portion 312. The arm 202A is elastically deformable and is movable upward by the tool 80. The hook portion 202D is thus disengaged from the engagement portion 312. In this state, the rear cover 3 is rotated in the second circumferential direction and removed from the motor compartment 21.

### Operation of Impact Tool

The operation of the power tool 1 will now be described. To perform a screwing operation on a workpiece, for example, the tip tool (screwdriver bit) for the screwing operation is placed into the tool hole 10C in the anvil 10. The tip tool in the tool hole 10C is held by the tool holder 11. After the tip tool is attached to the anvil 10, the operator grips the grip 22 with, for example, the right hand and pulls the trigger lever 14 with the right index finger. In response to the trigger lever 14 being pulled, power is supplied from the battery pack 25 to the motor 6 to activate the motor 6 and turn on the light assembly 18 simultaneously. In response to the activation of the motor 6, the rotor shaft 33 in the rotor 27 rotates. A rotational force of the rotor shaft 33 is then transmitted to the planetary gears 42 through the pinion gear 41. The planetary gears 42 revolve about the pinion gear 41 while rotating and meshing with the internal teeth on the internal gear 43. The planetary gears 42 are rotatably supported by the spindle 8 with a pin 42P. The revolving planetary gears 42 rotate the spindle 8 at a lower rotational speed than the rotor shaft 33.

When the spindle 8 rotates with the hammer projections 47D and the anvil projections 10B in contact with each other, the anvil 10 rotates together with the hammer 47 and the spindle 8. Thus, the screwing operation proceeds.

When the anvil 10 receives a predetermined or higher load as the screwing operation proceeds, the anvil 10 and the hammer 47 stop rotating. When the hammer 47 stops rotating and the spindle 8 rotates, the hammer 47 moves backward. Thus, the hammer projections 47D come out of contact with the anvil projections 10B. The hammer 47 that has moved backward moves forward while rotating under an elastic force from the coil spring 49. The anvil 10 is struck by the hammer 47 in the rotation direction. The anvil 10 thus rotates about the rotation axis AX at high torque. The screw is thus driven into the workpiece at high torque.

As described above, the power tool 1 according to the embodiment includes the motor 6 including the rotor 27 rotatable about the rotation axis AX extending in the front-rear direction and the stator 26, the anvil 10, as an output unit, located frontward from the motor 6 and rotatable in response to a rotational force from the rotor 27, the motor compartment 21 accommodating the motor 6, the grip 22 extending downward from the motor compartment 21, the rear rotor bearing 37 supporting the rear portion of the rotor 27, and the rear cover 3 covering the opening at the rear end of the motor compartment 21 and holding the rear rotor bearing 37. The motor compartment 21 includes the guides that guide the rear cover 3 in the first circumferential direction and frontward, the front-rear restrictor that restricts the front-rear movement of the rear cover 3 being guided by the guide, and the circumferential restrictor that restricts the circumferential movement of the rear cover 3 being restricted from the front-rear movement.

In the above structure, the front-rear movement and the circumferential movement of the rear cover 3 relative to the motor compartment 21 are restricted simply by rotating the rear cover 3 relative to the rear of the motor compartment 21 without using screws. More specifically, the rear cover 3 is fastened to the rear of the motor compartment 21 simply by rotating the rear cover 3 relative to the rear of the motor compartment 21 without using screws. This structure using no screws uses no bosses in the rear cover 3 and the motor compartment 21. The power tool 1 is thus less likely to be upsized. In particular, the rear cover 3 and the motor compartment 21 are less likely to be upsized in the lateral direction. The power tool 1 is thus less likely to have lower workability in a narrow space near, for example, a wall. The power tool 1 is assembled without using screws, reducing difficulty in assembly.

The motor compartment 21 in the embodiment includes the support surface 211 surrounding the rotation axis AX and facing rearward, the housing cylinder 200 protruding rearward from the support surface 211 and defining the opening, and the housing tabs 201 protruding radially outward from the outer circumferential surface of the housing cylinder 200. The guides are located on the housing tabs 201.

The rear cover 3 is thus guided by the housing tabs 201.

The housing tabs 201 in the embodiment each have the slope 201A sloping frontward in the first circumferential direction. The guides each include the slope 201A.

The rear cover 3 is thus guided along the slopes 201A in the first circumferential direction and frontward.

The front-rear restrictors in the embodiment are at least partially located on the corresponding housing tabs 201.

The housing tabs 201 restrict the front-rear movement of the rear cover 3.

The housing tabs 201 in the embodiment each have the front surface 201B facing frontward. The front-rear restrictors each include the front surface 201B. The front surfaces 201B restrict the rearward movement of the rear cover 3.

The front surfaces 201B of the housing tabs 201 thus restrict the rearward movement of the rear cover 3.

The support surface 211 in the embodiment surrounds the housing cylinder 200. The front surface 201B faces the support surface 211 with a space in between. The front-rear restrictors each include the support surface 211. The support surface 211 restricts the frontward movement of the rear cover 3.

The support surface 211 thus restricts the frontward movement of the rear cover 3.

The rear cover 3 in the embodiment includes the cover tabs 306 in contact with the corresponding housing tabs 201. The cover tabs 306 are guided along the corresponding slopes 201A and are located between the front surfaces 201B and the support surface 211.

This allows the rear cover 3 to be guided in the first circumferential direction and frontward simply by rotating the rear cover 3 once by a predetermined angle, restricting the front-rear movement of the rear cover 3.

The rear cover 3 in the embodiment includes the cover cylinder 302 surrounding the housing cylinder 200. The cover tabs 306 are located on the inner circumferential surface of the cover cylinder 302.

The housing tabs 201 and the cover tabs 306 are engageable with one another by rotating the rear cover 3 on the circumference of the housing cylinder 200.

In the embodiment, multiple housing tabs 201 are located circumferentially at intervals, and multiple cover tabs 306 are located circumferentially at intervals.

This stably guides the rear cover 3 and stably restricts the front-rear movement of the rear cover 3.

The rear cover 3 in the embodiment includes the cover tabs 306 guided by the guides.

The rear cover 3 is thus guided by the guides with the cover tabs 306.

The front-rear restrictors in the embodiment restrict the front-rear movement of the cover tabs 306.

This restricts the front-rear movement of the rear cover 3 with the cover tabs 306.

The circumferential restrictor in the embodiment is at a position different from the positions of the front-rear restrictors.

This reduces the complexity of the structures of the front-rear restrictors and the circumferential restrictor.

In the embodiment, the circumferential restrictor includes the hook 202 including the hook portion 202D hooked on the engagement portion 312 on the rear cover 3.

The hook portion 202D hooked on the engagement portion 312 restricts the circumferential movement of the rear cover 3.

In the embodiment, the hook 202 includes the arm 202A including the basal end 202B fixed to the motor compartment 21 and the distal end 202C including the hook portion 202D.

The hook portion 202D is thus smoothly hooked on the engagement portion 312.

The arm 202A in the embodiment elastically deforms to allow radial movement of the hook portion 202D.

The hook portion 202D is thus smoothly hooked on the engagement portion 312.

The rear cover 3 in the embodiment includes the cover cylinder 302 surrounding the housing cylinder 200. The circumferential restrictor is located radially outward from the cover cylinder 302.

This causes the outer circumferential surface of the housing cylinder 200 to face the inner circumferential surface of the cover cylinder 302. The rear cover 3 can thus rotate smoothly until its circumferential rotation is restricted by the circumferential restrictor.

The rear cover 3 in the embodiment includes the rib 311 protruding radially outward from the outer circumferential surface of the cover cylinder 302. The rib 311 is in contact with the distal end of the hook 202 with the hook portion 202D hooked on the engagement portion 312.

The rib 311 in contact with the distal end of the hook 202 restricts the circumferential movement of the rear cover 3.

In the embodiment, the hook portion 202D may restrict the movement of the rear cover 3 in the second circumferential direction, and the distal end of the hook 202 may restrict the movement of the rear cover 3 in the first circumferential direction.

This appropriately restricts the circumferential movement of the rear cover 3.

The rear cover 3 in the embodiment includes the middle lower plate 309 located radially outward from the hook 202. The middle lower plate 309 has the hole 313.

This allows access to the hook 202 through the hole 313. For example, to unfasten the rear cover 3, the tool 80 is inserted into the hole 313 to move the hook 202.

The power tool 1 according to the embodiment includes the elastic member 204 supported by the motor compartment 21 and located between the cover cylinder 302 and the middle lower plate 309.

The elastic member 204 reduces rattling of the rear cover 3.

As described above, the power tool 1 according to the embodiment includes the motor 6 including the rotor 27 rotatable about the rotation axis AX extending in the front-rear direction and the stator 26, the anvil 10, as an output unit, located frontward from the motor 6 and rotatable in response to a rotational force from the rotor 27, the left motor compartment and the right motor compartment accommodating the motor 6, the grip 22 extending downward from the left motor compartment and the right motor compartment, the rear rotor bearing 37 supporting the rear portion of the rotor 27, and the rear cover 3 fastened to the left motor compartment and the right motor compartment fastened together through engagement with the rear of the left motor compartment and the rear of the right motor compartment. The rear cover 3 holds the rear rotor bearing 37.

In the above structure, the rear cover 3 is fastened to the rear of the motor compartment 21 simply by engaging the rear cover 3 with the rear of the motor compartment 21 without using screws. This structure using no screws uses no bosses in the rear cover 3 and the motor compartment 21. The power tool 1 is thus less likely to be upsized. The power tool 1 is assembled without using screws, reducing difficulty in assembly.

In the embodiment, the left motor compartment and the right motor compartment are fastened together with the multiple screws 2S. The screws 2S are located frontward from the rotor core 32 in the rotor 27.

The rear cover 3 is thus fastened to the rear of the motor compartment 21 simply by engaging the rear cover 3 with the rear of the motor compartment 21 without using screws. The power tool 1 is thus less likely to be upsized. The power tool 1 is also less likely to have difficulty in assembly.

The rear cover 3 in the embodiment is located on the left of the left motor compartment and the right of the right motor compartment to prevent separation between the rear of the left motor compartment and the rear of the right motor compartment.

The rear cover 3 thus prevents separation between the left motor compartment and the right motor compartment.

In the embodiment, the rear cover 3 has the outlets 20 elongated in the vertical direction in its left and right side surfaces.

The air cooling the motor 6 is thus discharged through the outlets 20.

### 2. Second Embodiment

A second embodiment will be described. The same or corresponding components as those in the above embodiment are given the same reference numerals herein and will be described briefly or will not be described.

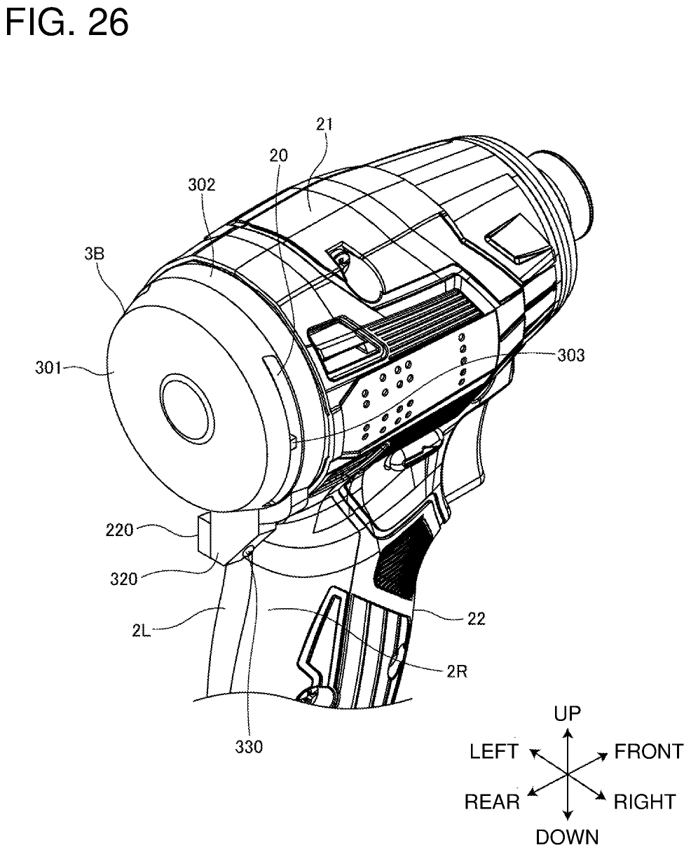

FIG. 26 is a rear perspective view of an upper portion of a power tool 1 according to the present embodiment. In the above embodiment, the circumferential restrictor includes the hook 202. The circumferential restrictor may include a screw.

A rear cover 3B shown in FIG. 26 includes the cover plate 301, the cover cylinder 302, and a protrusion 320. The protrusion 320 protrudes downward from the cover cylinder 302. A fixing portion 220 is fixed to the rear of the left housing 2L. The fixing portion 220 protrudes rearward from the rear of the grip 22 on the left housing 2L. The protrusion 320 and the fixing portion 220 are fastened with a screw 330. The screw 330 is placed through an opening in the protrusion 320 from the right of the protrusion 320 and into a threaded hole in the fixing portion 220. This restricts the circumferential movement of the rear cover 3B relative to the motor compartment 21.

### 3. Third Embodiment

A third embodiment will be described. The same or corresponding components as those in the above embodiments are given the same reference numerals herein and will be described briefly or will not be described.

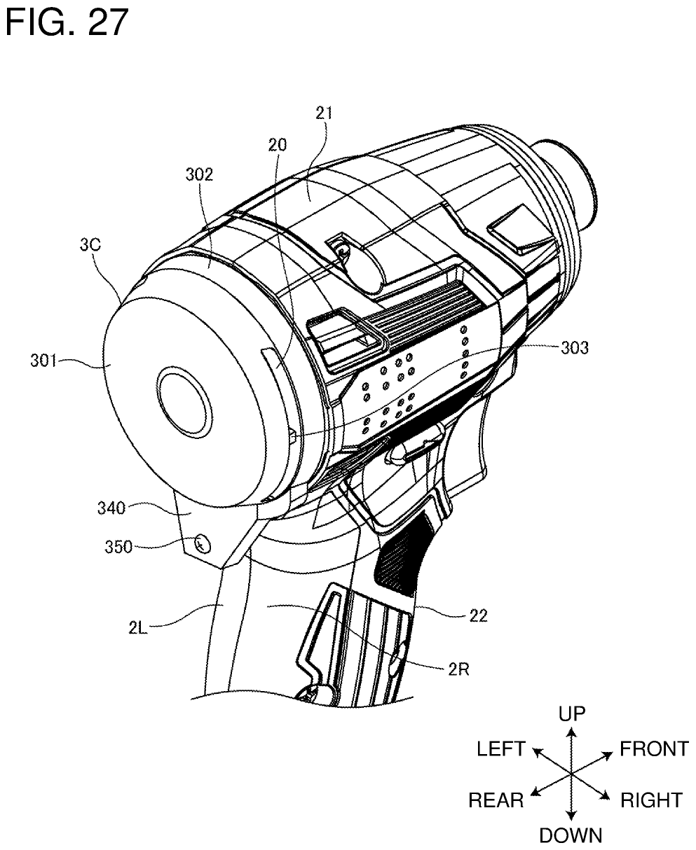

FIG. 27 is a rear perspective view of an upper portion of a power tool 1 according to the present embodiment. A rear cover 3C shown in FIG. 27 includes the cover plate 301, the cover cylinder 302, and a protrusion 340. The protrusion 340 protrudes downward from the cover cylinder 302. The protrusion 340 and the grip 22 are fastened with a screw 350. The screw 350 is placed through an opening in the protrusion 340 from the rear of the protrusion 340 and into a threaded hole in the grip 22. This restricts the circumferential movement of the rear cover 3C relative to the motor compartment 21.

### 4. Fourth Embodiment

A fourth embodiment will be described. The same or corresponding components as those in the above embodiments are given the same reference numerals herein and will be described briefly or will not be described.

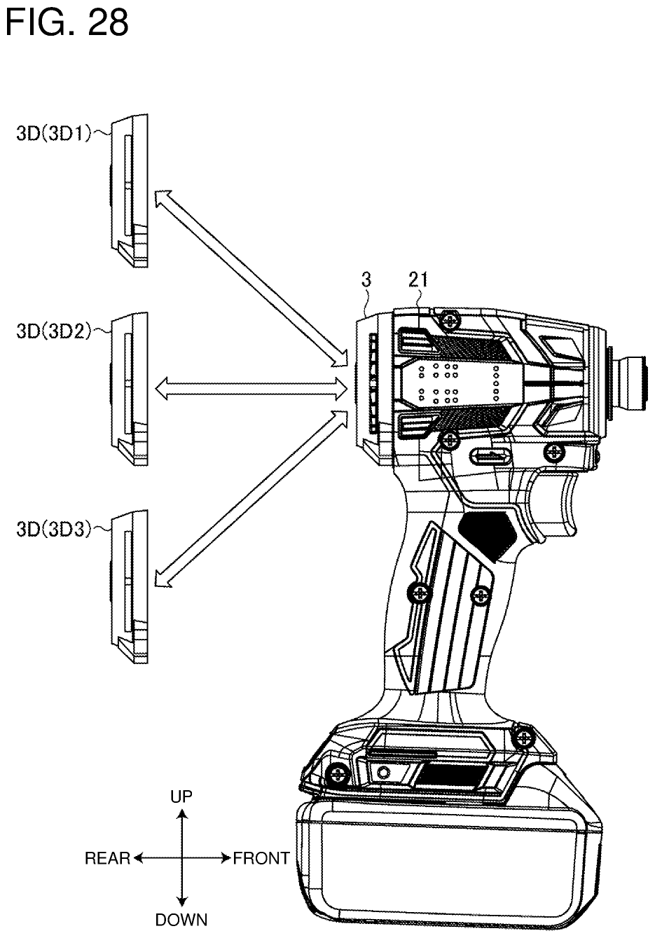

FIG. 28 is a schematic diagram of a power tool 1 according to the present embodiment. As in the first embodiment described above, the rear cover 3 covers the opening at the rear end of the motor compartment 21. The rear cover 3 is fastened to the rear of the motor compartment 21 without using screws. The rear cover 3 holds the rear rotor bearing 37. The rear cover 3 is attachable to and detachable from the motor compartment 21. The rear cover 3 is fastened to the motor compartment 21 simply through engagement between them. The rear cover 3 is formed from a synthetic resin.

The rear cover 3 is replaceable with a rear cover 3D different from the rear cover 3 in color. Similarly to the rear cover 3, the rear cover 3D also includes the cover plate 301 and the cover cylinder 302. The cover cylinder 302 protrudes frontward from the rim of the cover plate 301 and surrounds the rear of the motor compartment 21. The rear cover 3D is fastened to the rear of the motor compartment 21 without using screws. The rear cover 3D holds the rear rotor bearing 37. The rear cover 3D is attachable to and detachable from the motor compartment 21. The rear cover 3D is fastened to the motor compartment 21 simply through engagement between them.

The rear cover 3D includes a first color rear cover 3D1, a second color rear cover 3D2, and a third color rear cover 3D3. The second color is different from the first color. The third color is different from the first color and from the second color. The rear cover 3 and the rear cover 3D are replaceable with each other, thus allowing the user of the power tool 1 to customize the power tool 1 as appropriate. The rear cover 3 replaced with the rear cover 3D allows the user of the power tool 1 to identify the power tool 1 by color.

### 5. Fifth Embodiment

A fifth embodiment will be described. The same or corresponding components as those in the above embodiments are given the same reference numerals herein and will be described briefly or will not be described.

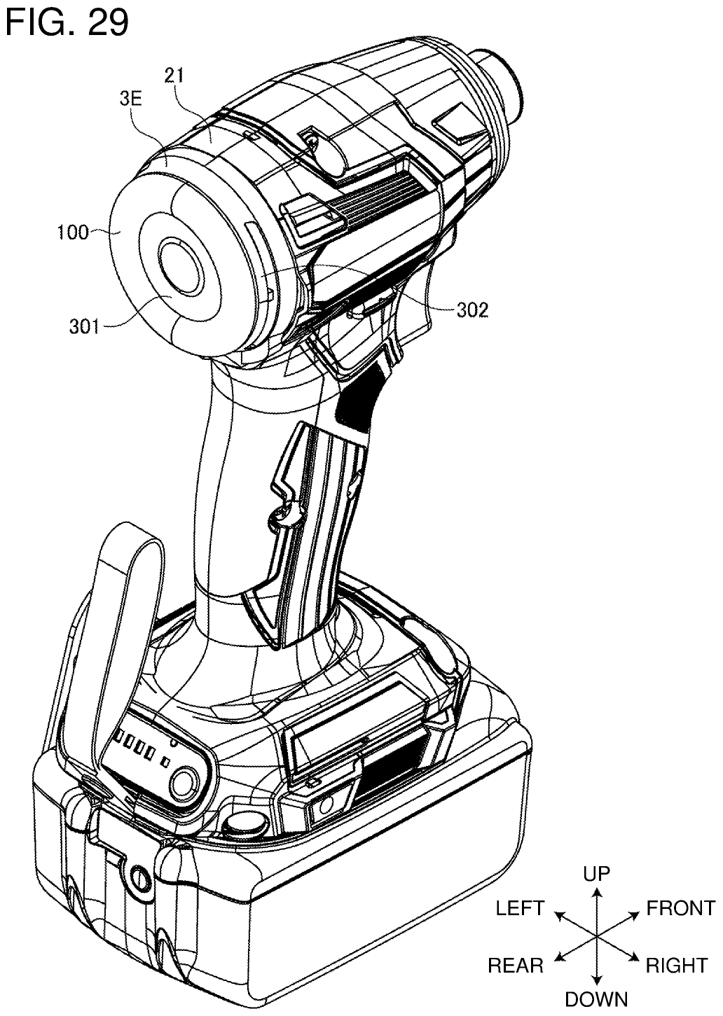

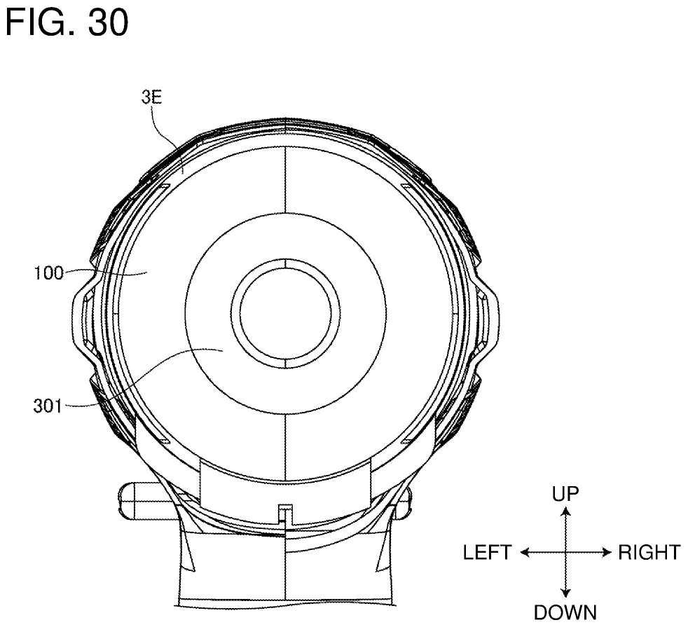

FIG. 29 is a rear perspective view of a power tool 1 according to the present embodiment. FIG. 30 is a rear view of a rear cover 3E. As shown in FIGS. 29 and 30, the rear cover 3 described in the above first embodiment is replaceable with a rear cover 3E including a luminous material portion 100. The rear cover 3E including the luminous material portion 100 differs from the rear cover 3 in shape. The luminous material portion 100 differs from the rear cover 3 in composition and color. The composition includes a material.

Similarly to the rear cover 3, the rear cover 3E also includes the cover plate 301 and the cover cylinder 302. The cover cylinder 302 protrudes frontward from the rim of the cover plate 301 and surrounds the rear of the motor compartment 21. The rear cover 3E holds the rear rotor bearing 37. The rear cover 3E is attachable to and detachable from the motor compartment 21. The rear cover 3E is fastened to the motor compartment 21 simply through engagement between them.

The luminous material portion 100 is located annularly on the rear surface of the cover plate 301.

The rear cover 3 and the rear cover 3E are replaceable with each other, thus allowing the user of the power tool 1 to customize the power tool 1 as appropriate. The rear cover 3 replaced with the rear cover 3E allows the user of the power tool 1 to identify the power tool 1. The luminous material portion 100 allows the user of the power tool 1 to identify the power tool 1 in situations of, for example, at night.

The rear cover 3E may have the same shape as the rear cover 3. At least a part of the rear cover 3E may be formed from a luminous material.

### 6. Sixth Embodiment

A sixth embodiment will be described. The same or corresponding components as those in the above embodiments are given the same reference numerals herein and will be described briefly or will not be described.

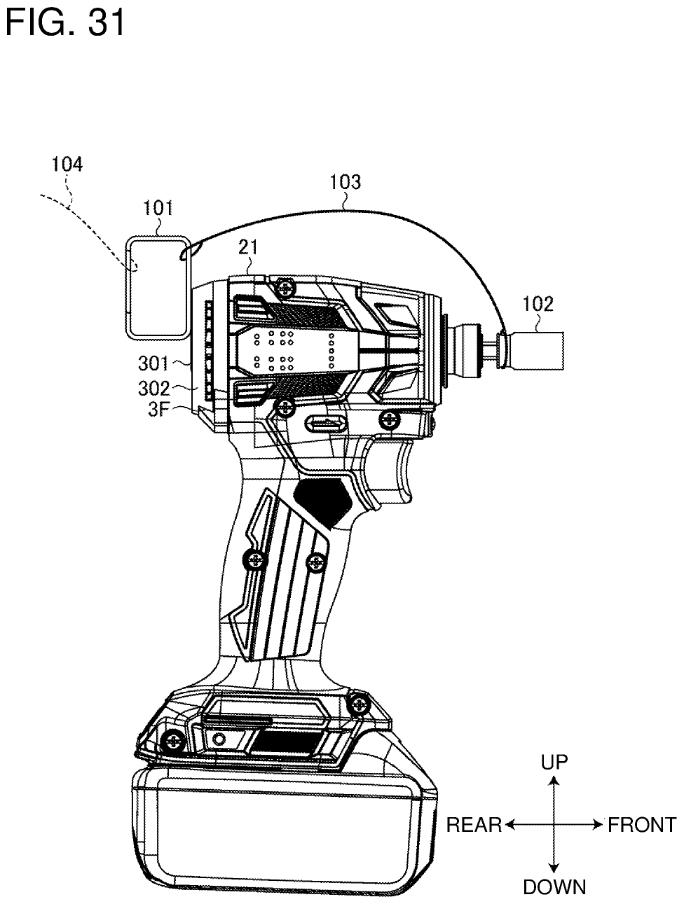

FIG. 31 is a side view of a power tool 1 according to the present embodiment. As shown in FIG. 31, the rear cover 3 described in the above first embodiment is replaceable with a rear cover 3F including a hook portion 101. The rear cover 3F including the hook portion 101 differs from the rear cover 3 in shape. The hook portion 101 differs from the rear cover 3 in composition and color.

Similarly to the rear cover 3, the rear cover 3F also includes the cover plate 301 and the cover cylinder 302. The cover cylinder 302 protrudes frontward from the rim of the cover plate 301 and surrounds the rear of the motor compartment 21. The rear cover 3F holds the rear rotor bearing 37. The rear cover 3F is attachable to and detachable from the motor compartment 21. The rear cover 3F is fastened to the motor compartment 21 simply through engagement between them. The hook portion 101 is fixed to the rear surface of the cover plate 301.

As shown in FIG. 31, a socket 102 may be attached to the anvil 10. The socket 102 has a hexagonal hole in its front end. The socket 102 has, in its rear, an insertion portion insertable into the tool hole 10C in the anvil 10. With the head of a bolt received in the hexagonal hole in the socket 102, the bolt is driven into a workpiece as the anvil 10 rotates.

The socket 102 is connected to the hook portion 101 with a connector 103. The connector 103 is a wire. The connector 103 may include a cord, a chain, or a flexible tube. The connector 103 has one end attached to the front of the socket 102. The connector 103 has the other end attached to the hook portion 101. The front of the socket 102 is held by the hook portion 101 with the connector 103 to reduce the likelihood that the front of the socket 102 falls off when the socket 102 is broken in the middle.

The power tool 1 may be connected to the operator with a connector 104 connected to the hook portion 101.

The rear cover 3 and the rear cover 3F are replaceable with each other, thus allowing the user of the power tool 1 to customize the power tool 1 as appropriate.

### 7. Seventh Embodiment

A seventh embodiment will be described. The same or corresponding components as those in the above embodiments are given the same reference numerals herein and will be described briefly or will not be described.

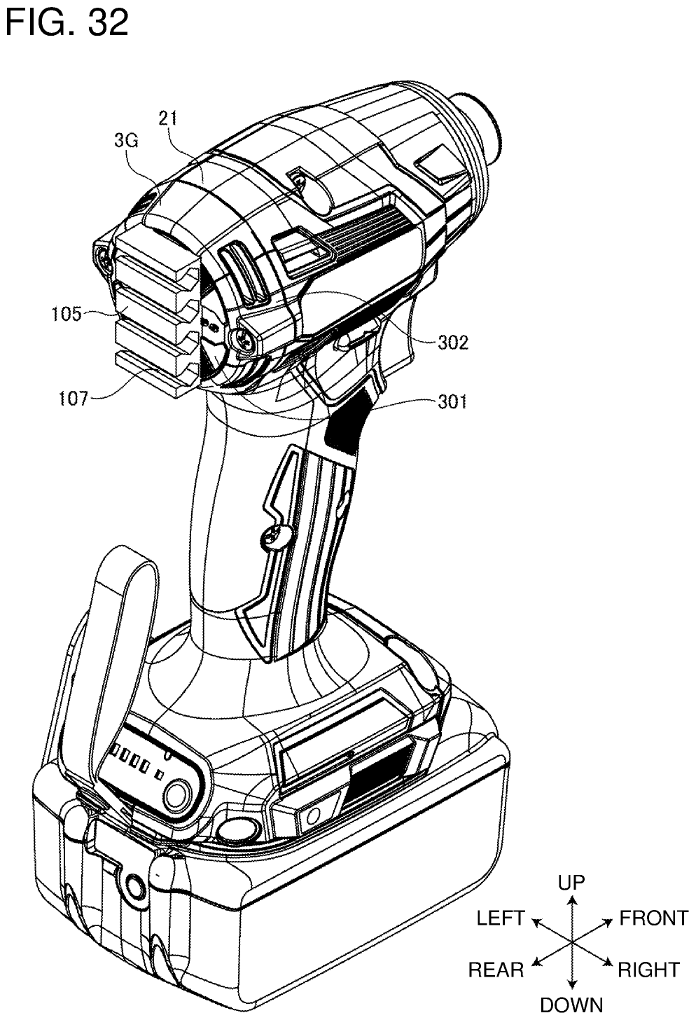

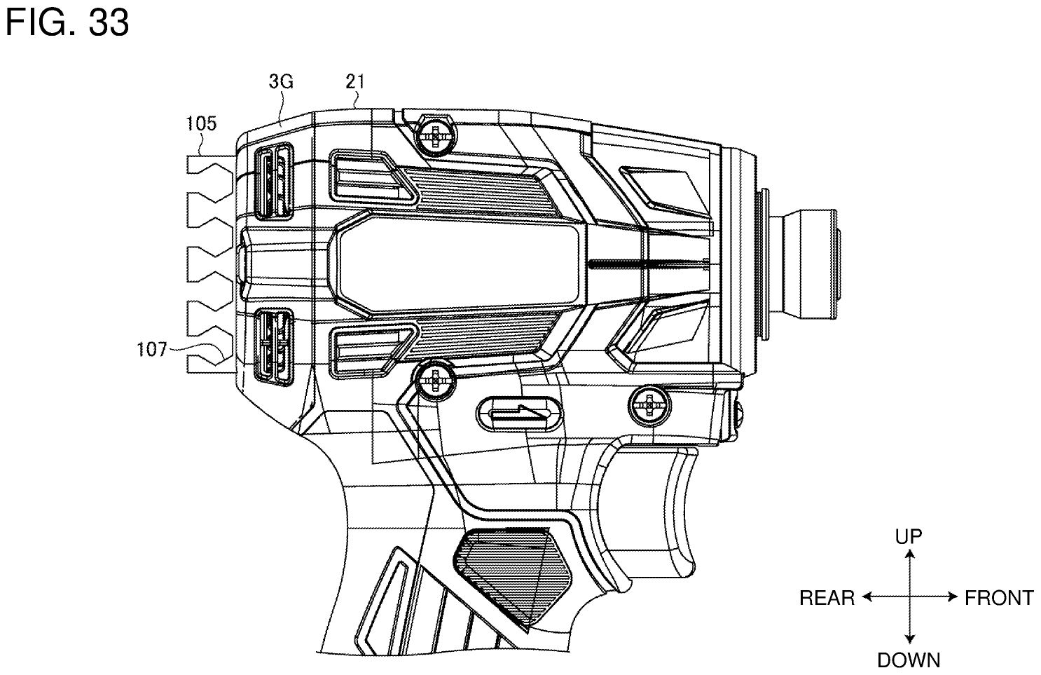

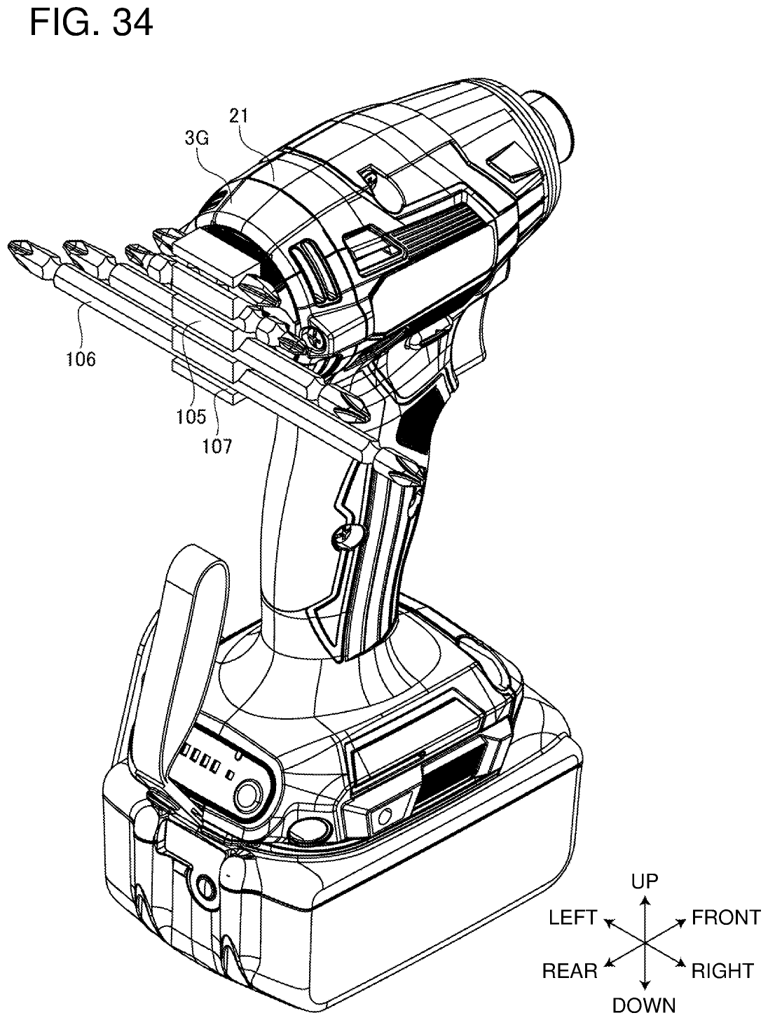

FIG. 32 is a rear perspective view of a power tool 1 according to the present embodiment. FIG. 33 is a side view of an upper portion of the power tool 1. FIG. 34 is a rear perspective view of the power tool 1.

As shown in FIGS. 32 to 34, the rear cover 3 described in the above first embodiment is replaceable with a rear cover 3G including a tool holder 105. The rear cover 3G including the tool holder 105 differs from the rear cover 3 in shape. The tool holder 105 differs from the rear cover 3 in composition and color.

Similarly to the rear cover 3, the rear cover 3G also includes the cover plate 301 and the cover cylinder 302. The cover cylinder 302 protrudes frontward from the rim of the cover plate 301 and surrounds the rear of the motor compartment 21. The rear cover 3G holds the rear rotor bearing 37. The rear cover 3G is attachable to and detachable from the motor compartment 21. The rear cover 3G is fastened to the motor compartment 21 simply through engagement between them. The tool holder 105 is fixed to the rear surface of the cover plate 301.

The tool holder 105 has multiple holding grooves 107 to hold tools 106. The holding grooves 107 extend laterally.

The rear cover 3 and the rear cover 3F are replaceable with each other, thus allowing the user of the power tool 1 to customize the power tool 1 as appropriate. With the tool holder 105 holding different types of tools 106, the user of the power tool 1 can efficiently replace the tool 106 for an intended operation.

### 8. Eighth Embodiment

An eighth embodiment will be described. The same or corresponding components as those in the above embodiments are given the same reference numerals herein and will be described briefly or will not be described.

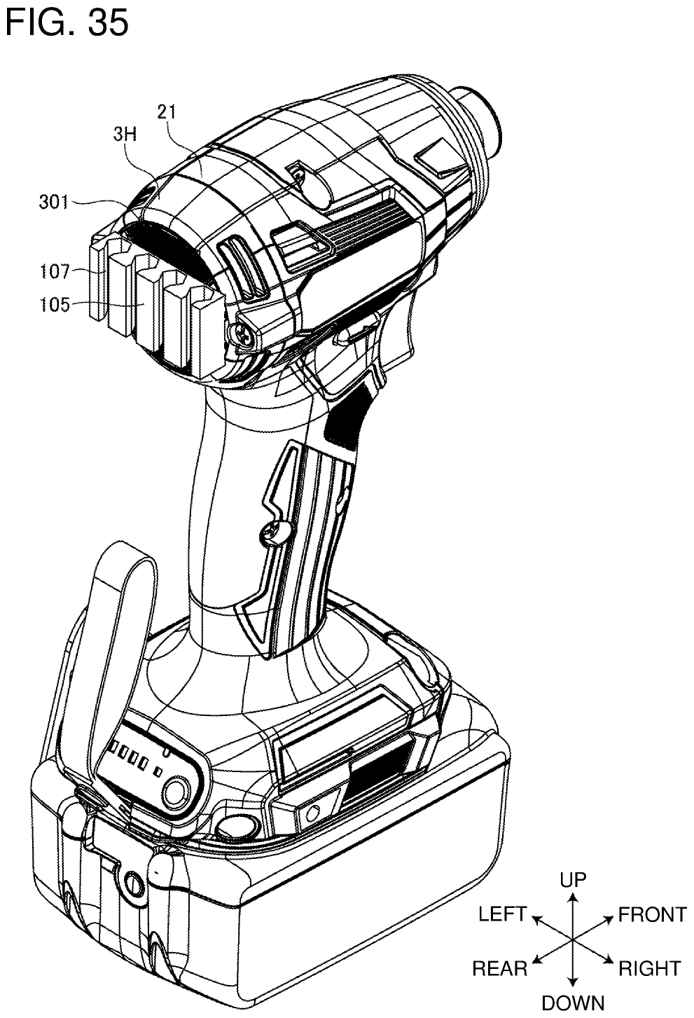

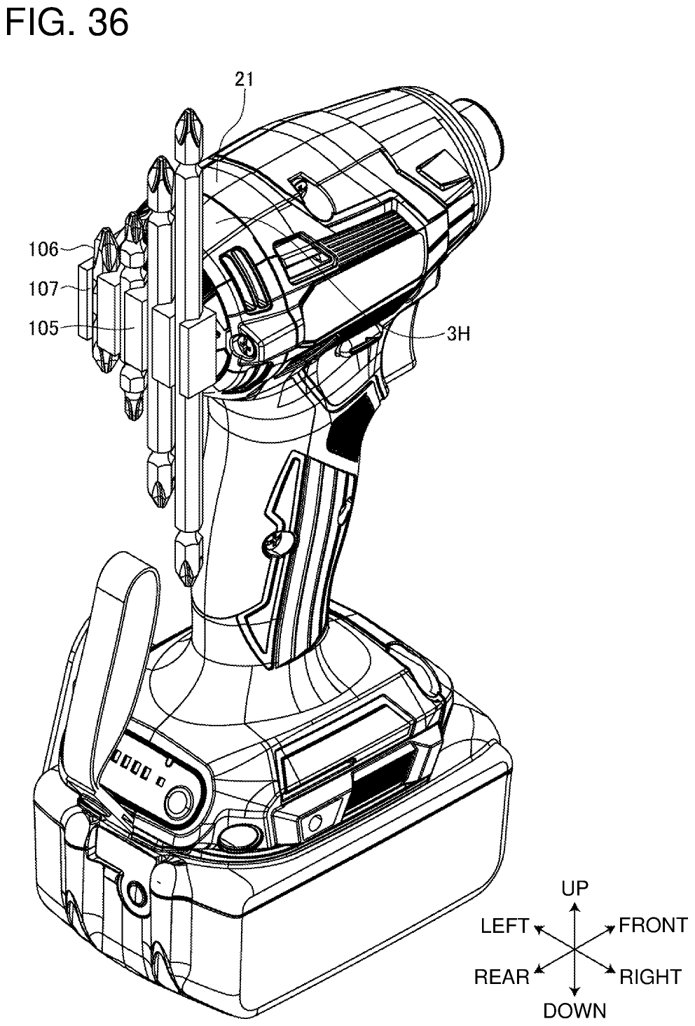

FIG. 35 is a rear perspective view of a power tool 1 according to the present embodiment. FIG. 36 is a rear perspective view of the power tool 1.

The eighth embodiment is a modification of the seventh embodiment described above. As shown in FIGS. 35 and 36, the rear cover 3 described in the above first embodiment is replaceable with a rear cover 3H including the tool holder 105. The tool holder 105 has multiple holding grooves 107 to hold the tools 106. The holding grooves 107 extend vertically.

### 9. Ninth Embodiment

A ninth embodiment will be described. The same or corresponding components as those in the above embodiments are given the same reference numerals herein and will be described briefly or will not be described.

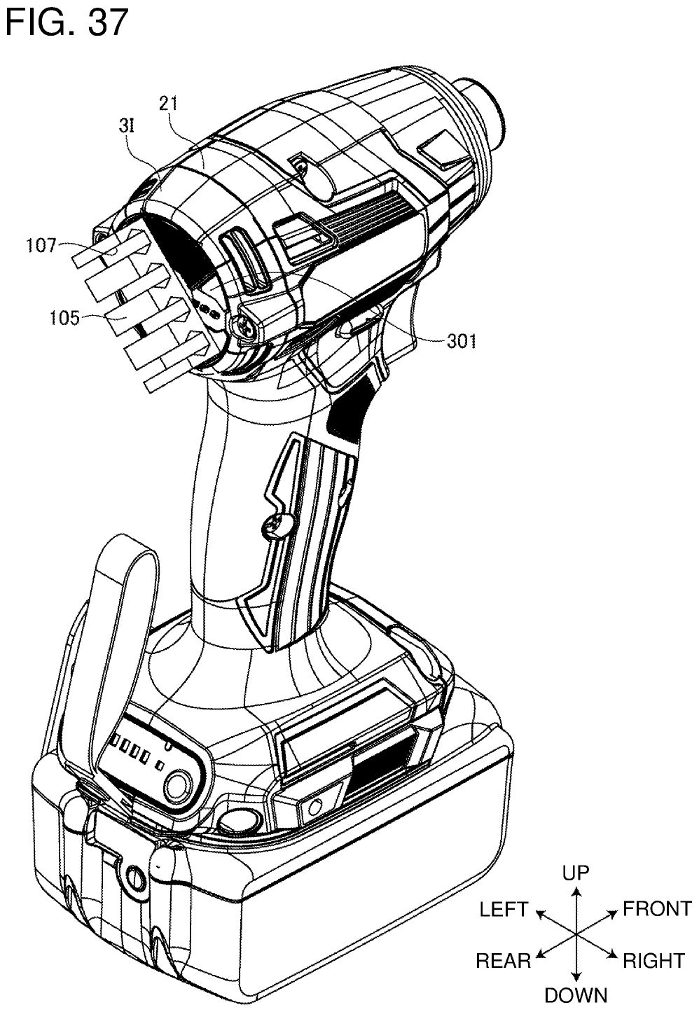

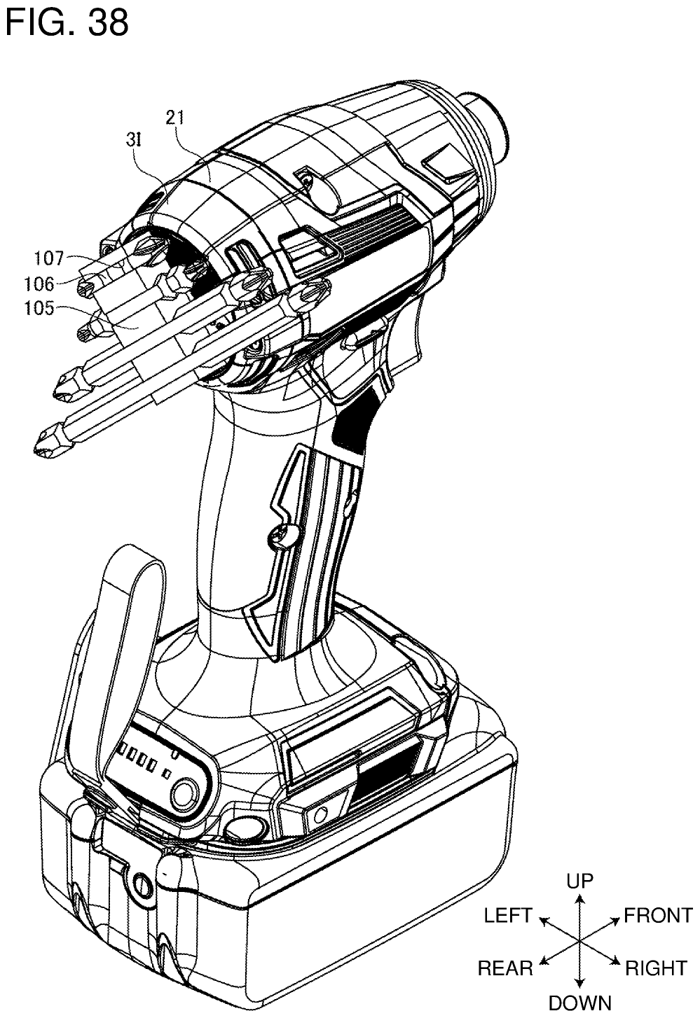

FIG. 37 is a rear perspective view of a power tool 1 according to the present embodiment. FIG. 38 is a rear perspective view of the power tool 1 according to the embodiment.

The ninth embodiment is a modification of the seventh embodiment and the eighth embodiment described above. As shown in FIGS. 37 and 38, the rear cover 3 described in the above first embodiment is replaceable with a rear cover 3I including the tool holder 105. The tool holder 105 has multiple holding grooves 107 to hold the tools 106. The holding grooves 107 extend in an oblique direction oblique to the lateral direction and to the vertical direction.

### 10. Tenth Embodiment

A tenth embodiment will be described. The same or corresponding components as those in the above embodiments are given the same reference numerals herein and will be described briefly or will not be described.

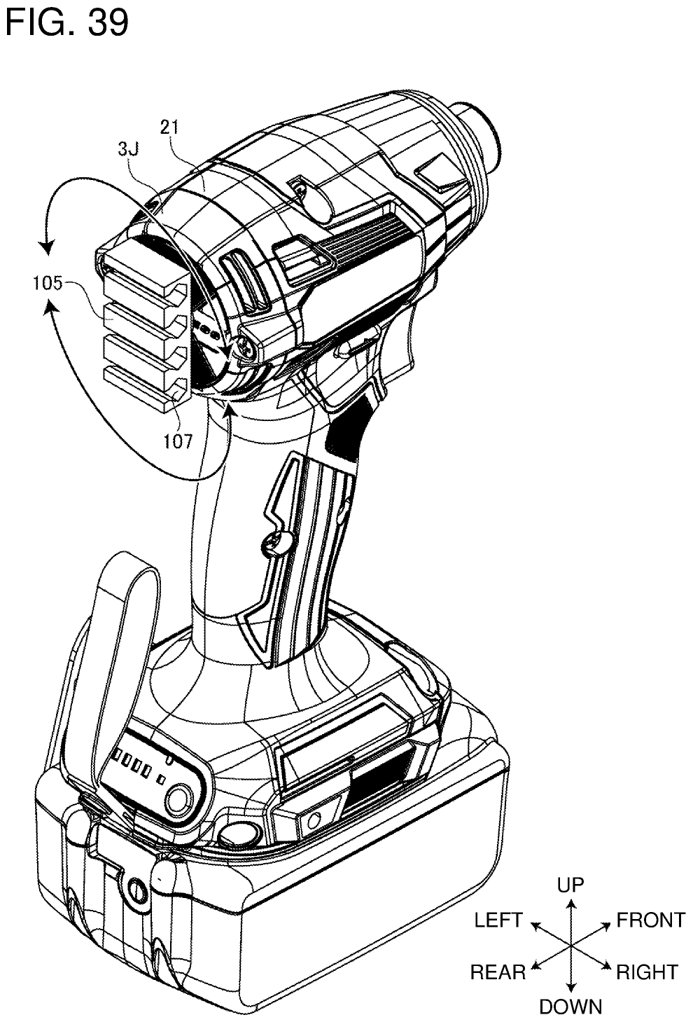

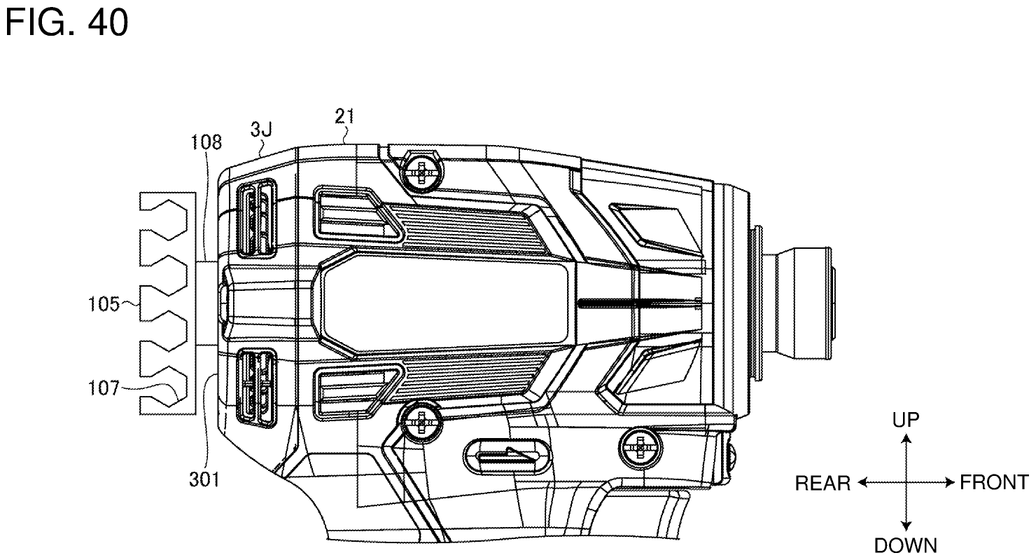

FIG. 39 is a rear perspective view of a power tool 1 according to the present embodiment. FIG. 40 is a side view of an upper portion of the power tool 1.

The tenth embodiment is a modification of the seventh to ninth embodiments described above. As shown in FIGS. 39 and 40, the rear cover 3 described in the above first embodiment is replaceable with a rear cover 3J including the tool holder 105. The tool holder 105 has multiple holding grooves 107 to hold the tools 106. The tool holder 105 is connected to the cover plate 301 with a rotation assembly 108. The tool holder 105 is supported on the cover plate 301 in a rotatable manner. The tool holder 105 is rotatable about the rotation axis AX. The holding grooves 107 can thus extend in an intended direction.

### 11. Eleventh Embodiment

An eleventh embodiment will be described. The same or corresponding components as those in the above embodiments are given the same reference numerals herein and will be described briefly or will not be described.

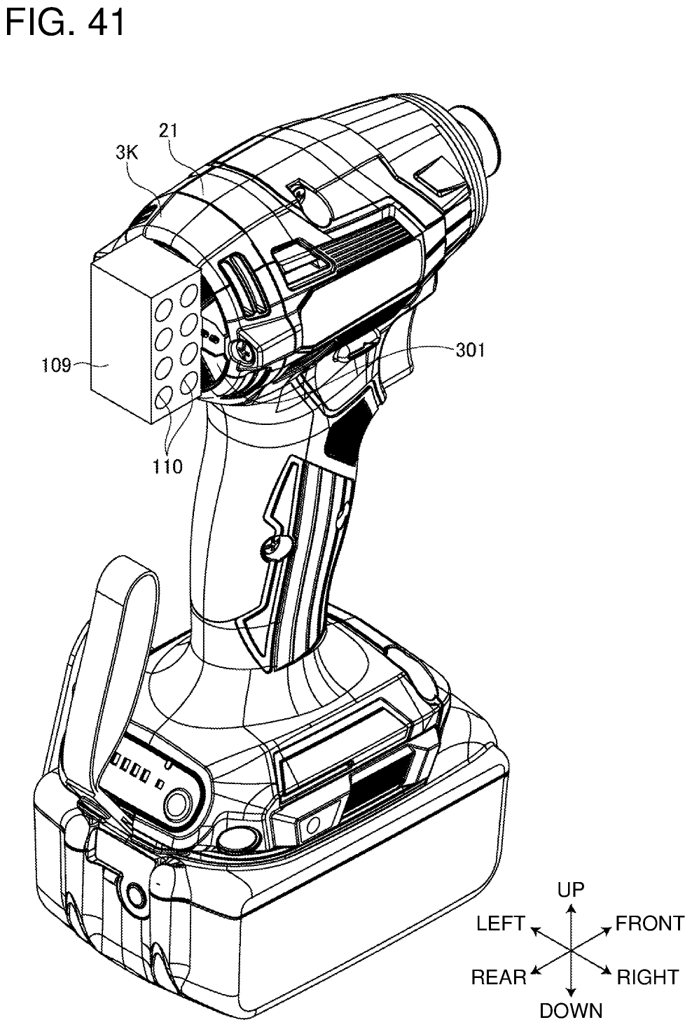

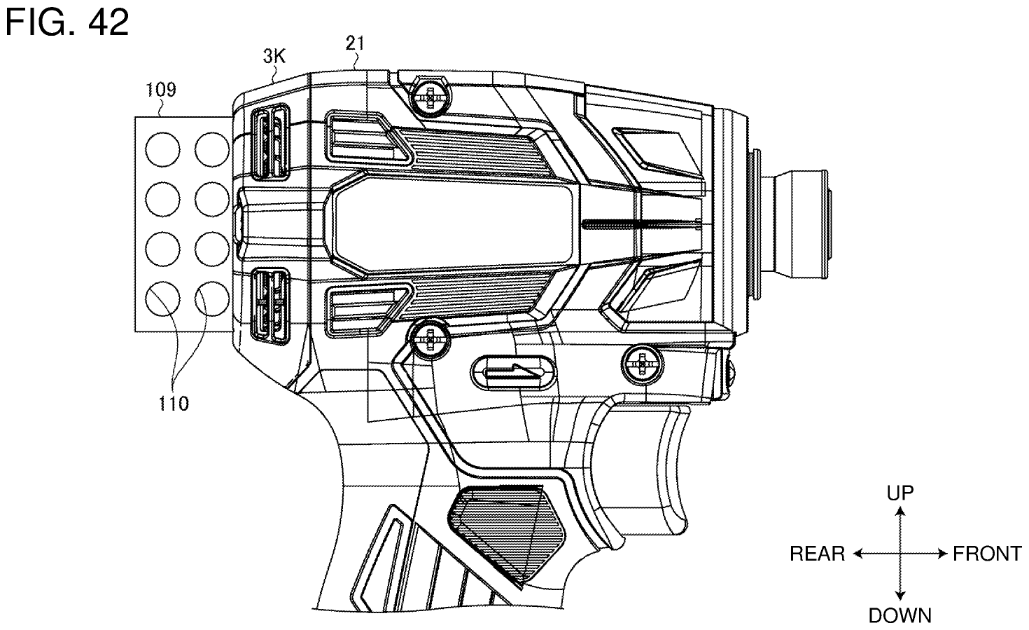

FIG. 41 is a rear perspective view of a power tool 1 according to the present embodiment. FIG. 42 is a side view of an upper portion of the power tool 1.

The eleventh embodiment is a modification of the seventh embodiment described above. As shown in FIGS. 41 and 42, the rear cover 3 described in the above first embodiment is replaceable with a rear cover 3K including a tool holder 109. The tool holder 109 has multiple holding holes 110 to hold the tools 106. The holding holes 110 extend laterally.

The holding holes 110 may extend vertically. The holding holes 110 may extend in an oblique direction oblique to the lateral direction and to the vertical direction. The tool holder 109 may be supported on the cover plate 301 in a rotatable manner.

### 12. Twelfth Embodiment

A twelfth embodiment will be described. The same or corresponding components as those in the above embodiments are given the same reference numerals herein and will be described briefly or will not be described.

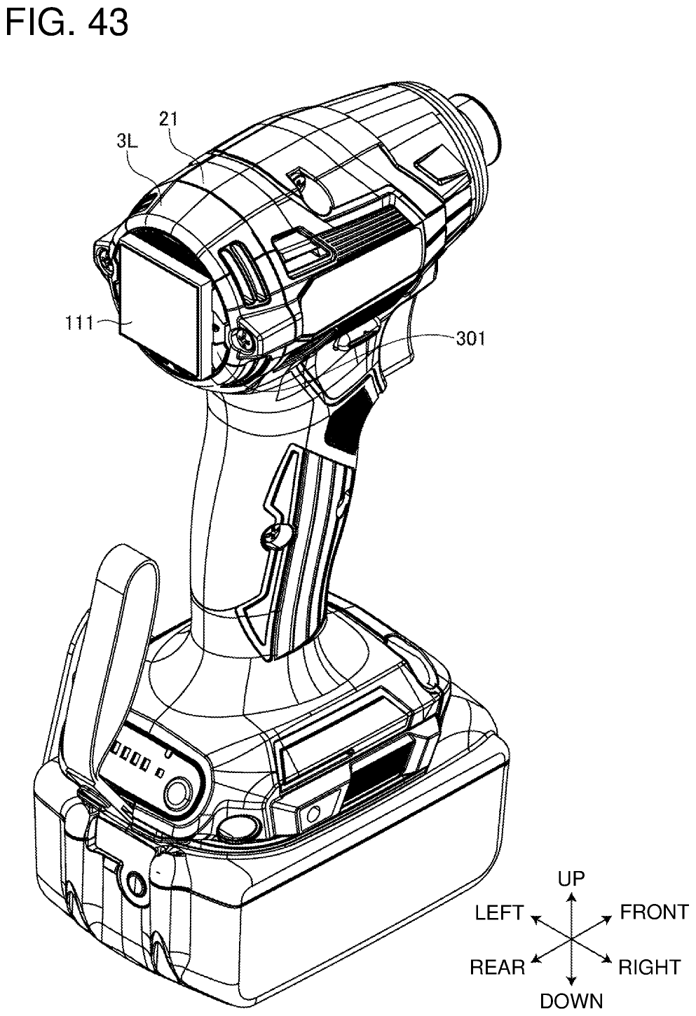

FIG. 43 is a rear perspective view of a power tool 1 according to the present embodiment. As shown in FIG. 43, the rear cover 3 described in the above first embodiment is replaceable with a rear cover 3L including a plate 111. The rear cover 3L including the plate 111 differs from the rear cover 3 in shape. The plate 111 differs from the rear cover 3 in composition and color.

Similarly to the rear cover 3, the rear cover 3L also includes the cover plate 301 and the cover cylinder 302. The cover cylinder 302 protrudes frontward from the rim of the cover plate 301 and surrounds the rear of the motor compartment 21. The rear cover 3L holds the rear rotor bearing 37. The rear cover 3L is attachable to and detachable from the motor compartment 21. The rear cover 3L is fastened to the motor compartment 21 simply through engagement between them. The plate 111 is fixed to the rear surface of the cover plate 301.

The plate 111 has a flat surface (rear surface). The user of the power tool 1 may attach a sticky note or a label on the plate 111. The plate 111 has a water-repellent surface. The plate 111 may come in contact with water at an angle of 90 degrees or greater, 100 degrees or greater, or 110 degrees or greater. The plate 111 may be a whiteboard.

The rear cover 3 and the rear cover 3L are replaceable with each other, thus allowing the user of the power tool 1 to customize the power tool 1 as appropriate. The plate 111 being a whiteboard allows the user of the power tool 1 to write an operation procedure on the whiteboard.

### 13. Thirteenth Embodiment

A thirteenth embodiment will be described. The same or corresponding components as those in the above embodiments are given the same reference numerals herein and will be described briefly or will not be described.

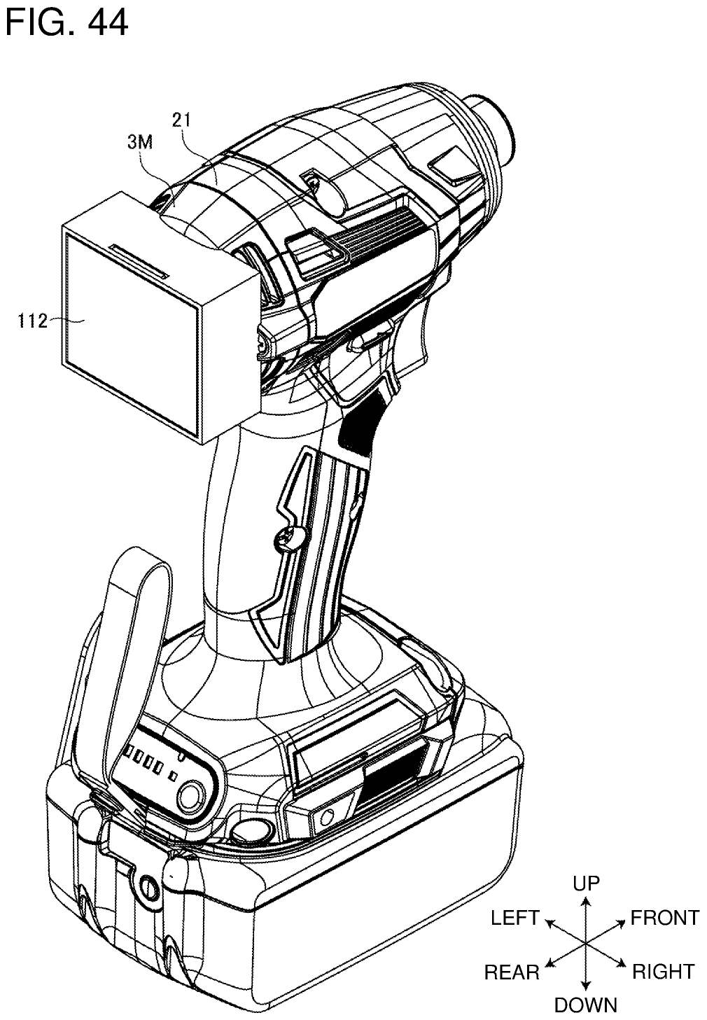

FIG. 44 is a rear perspective view of a power tool 1 according to the present embodiment. As shown in FIG. 44, the rear cover 3 described in the above first embodiment is replaceable with a rear cover 3M including a communicator 112. The rear cover 3M including the communicator 112 differs from the rear cover 3 in shape. The communicator 112 differs from the rear cover 3 in composition and color.

The communicator 112 includes a global navigation satellite system (GNSS) receiver and a transmitter that transmits detection signals from the GNSS receiver. The GNSS receiver uses the GNSS to detect the position of the power tool 1. The GNSS includes the global positioning system (GPS). The transmitter transmits information about the position of the power tool 1 detected by the GNSS receiver. For the power tool 1 used at an industrial facility, the transmitter may transmit information about the position of the power tool 1 to a management computer of the industrial facility. The transmitter may transmit information about the position of the power tool 1 to a mobile terminal held by the user of the power tool 1 through a server.

The rear cover 3 and the rear cover 3M are replaceable with each other, thus allowing the user of the power tool 1 to customize the power tool 1 as appropriate. The communicator 112 including the GNSS receiver allows management of the information about the position of the power tool 1.

The communicator 112 may not include a GNSS receiver. The communicator 112 may, for example, transmit identification data about the power tool 1 to a management computer or to a mobile terminal. The communicator 112 may include a radio frequency identification (RFID) system.

### 14. Fourteenth Embodiment

A fourteenth embodiment will be described. The same or corresponding components as those in the above embodiments are given the same reference numerals herein and will be described briefly or will not be described.

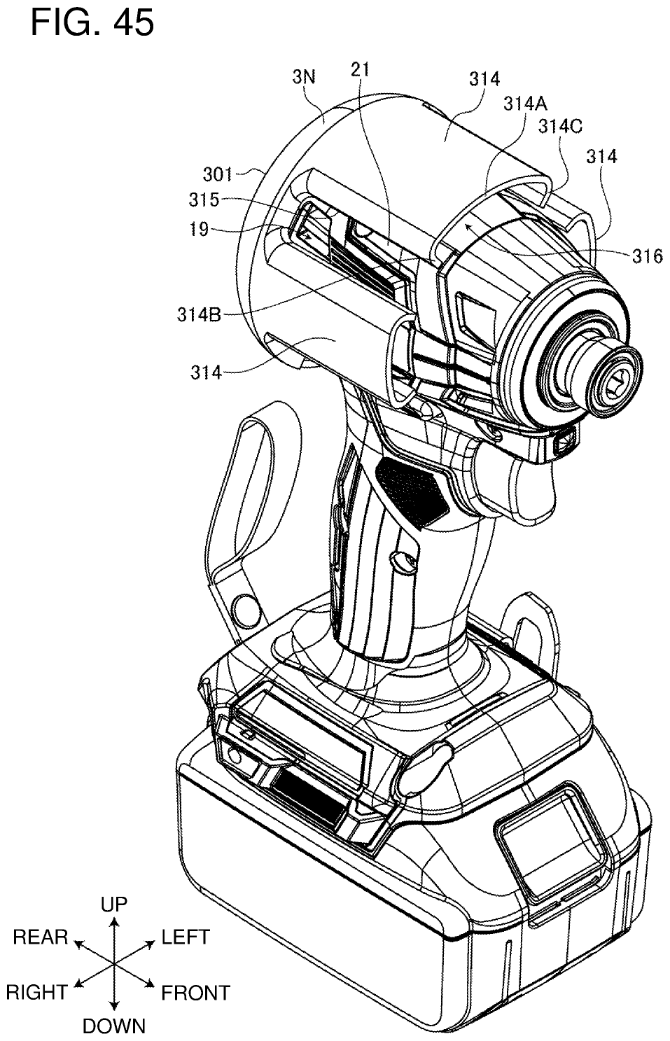

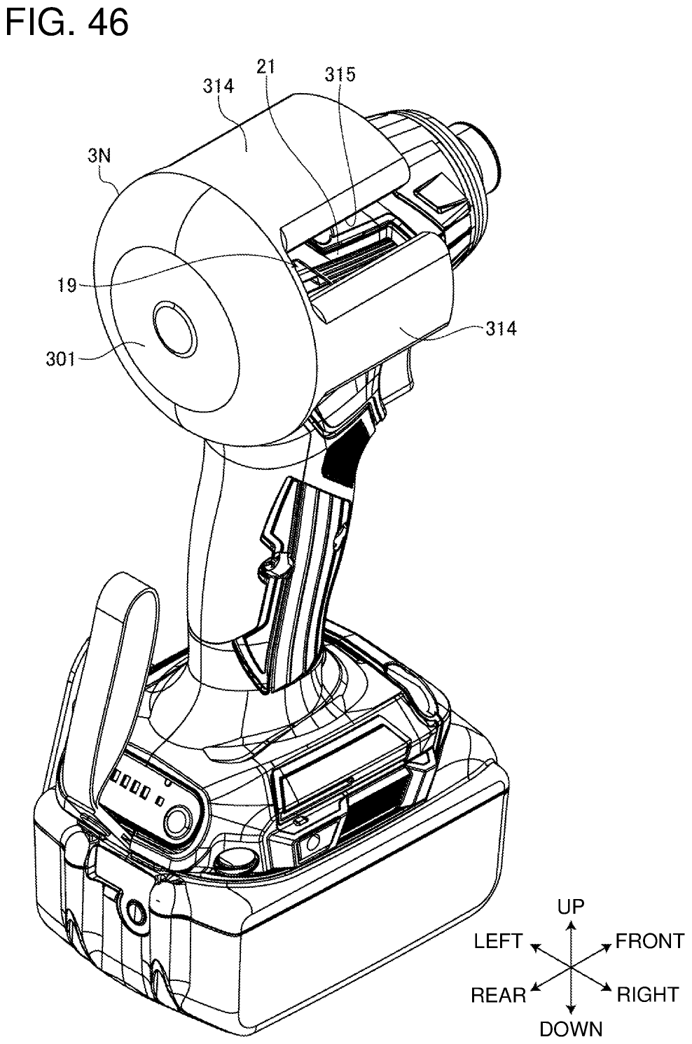

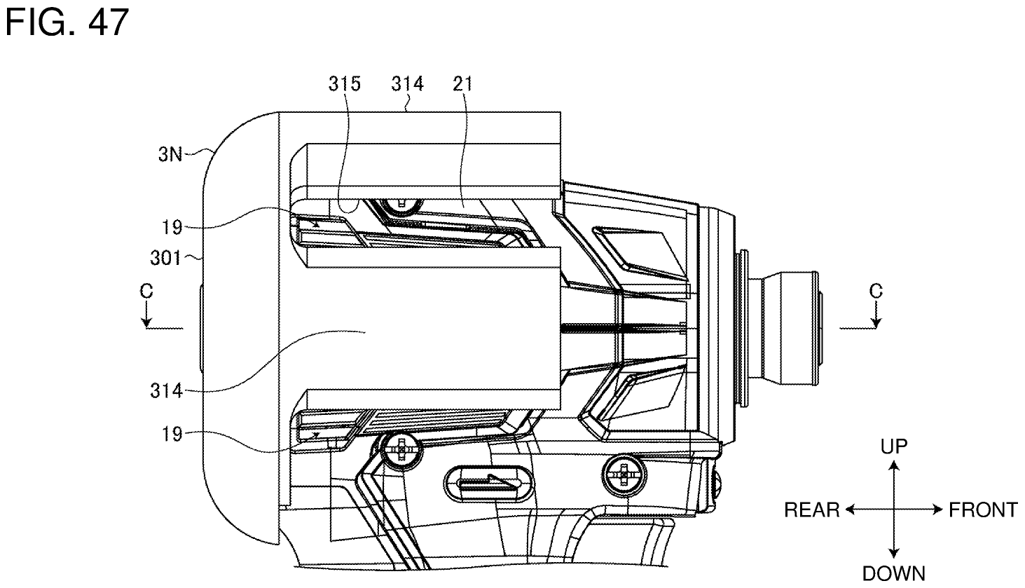

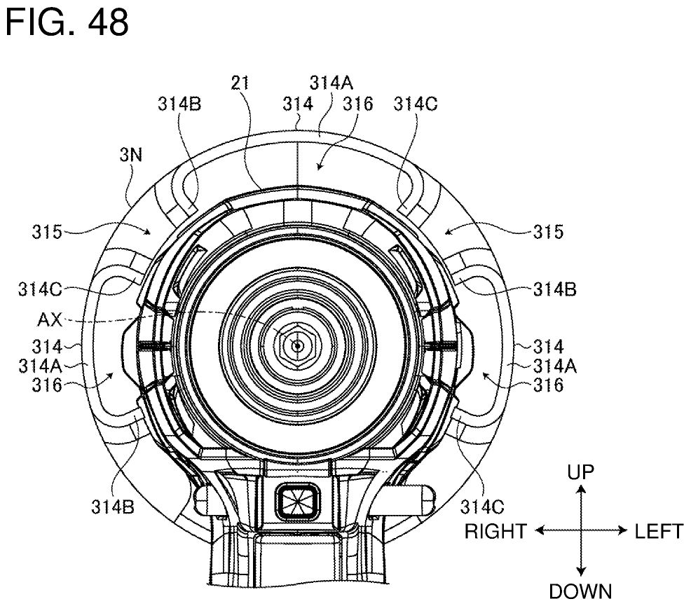

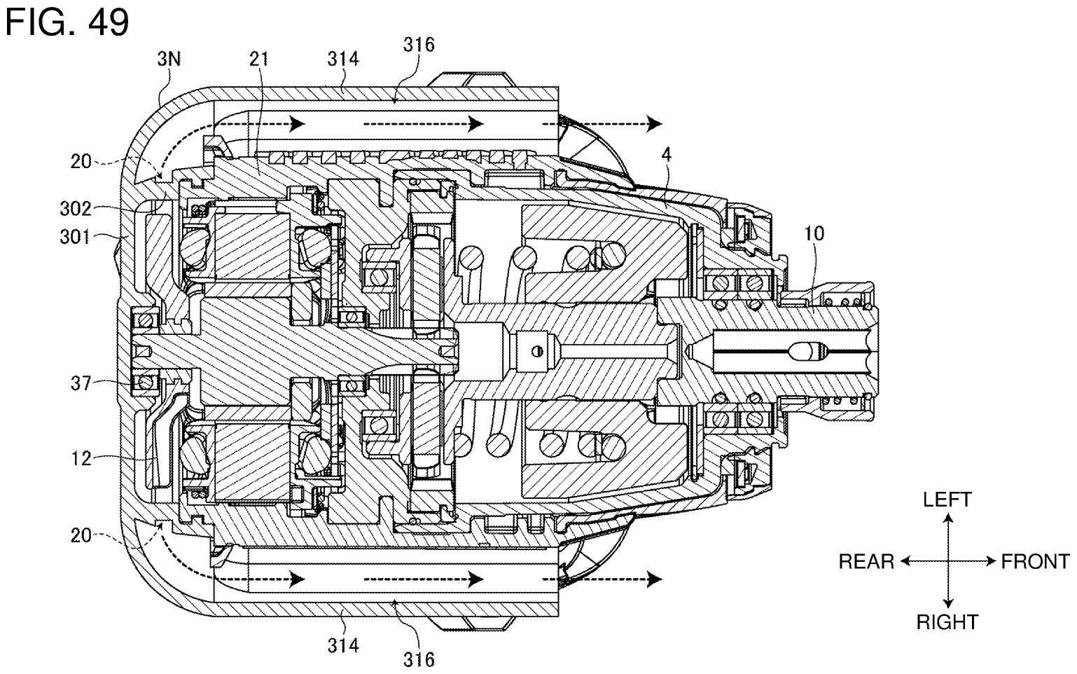

FIG. 45 is a front perspective view of a power tool 1 according to the present embodiment. FIG. 46 is a rear perspective view of the power tool 1. FIG. 47 is a side view of an upper portion of the power tool 1. FIG. 48 is a front view of the upper portion of the power tool 1. FIG. 49 is a horizontal sectional view of the upper portion of the power tool 1. FIG. 49 is a cross-sectional view taken along line C-C in FIG. 47 as viewed in the direction indicated by the arrows.

As shown in FIGS. 45 to 49, the rear cover 3 described in the above first embodiment is replaceable with a rear cover 3N including guides 314. The rear cover 3N including the guides 314 differs from the rear cover 3 in shape. The guides 314 may be the same as or differ from the rear cover 3 in composition. The guides 314 may be the same as or differ from the rear cover 3 in color.

The rear cover 3N includes the cover plate 301, the cover cylinder 302, and the guides 314. The cover plate 301 is a disk. The cover plate 301 includes, on its front surface, the protrusion 304 holding the rear rotor bearing 37. The cover cylinder 302 protrudes frontward from the rim of the cover plate 301. The cover cylinder 302 surrounds the rear of the motor compartment 21. The rear cover 3N is attachable to and detachable from the motor compartment 21. The rear cover 3N is fastened to the motor compartment 21 simply through engagement between them.

The cover cylinder 302 has the outlets 20. The outlets 20 are located in the right and left portions of the cover cylinder 302.

The guides 314 guide air discharged through the outlets 20 to the front end of the anvil 10 serving as an output unit in the power tool 1.

The guides 314 protrude frontward from the rim of the cover plate 301. The guides 314 are located radially outward from the cover cylinder 302. Each guide 314 has its front end located frontward from the front end of the cover cylinder 302. Each guide 314 in the embodiment has its front end located radially outward from the hammer case 4. The front ends of the guides 314 are aligned with at least a part of the hammer case 4 in the front-rear direction.

Multiple guides 314 are located circumferentially at intervals. The guides 314 are located leftward from, rightward from, and above the motor compartment 21. The adjacent guides 314 define a recess 315. The inlets 19 are in the recesses 315. The guides 314 are located not to cover the inlets 19.

As shown in FIG. 48, each guide 314 has an arc 314A, a first wall 314B, and a second wall 314C. The first wall 314B is located on the arc 314A in the first circumferential direction. The second wall 314C is located on the arc 314A in the second circumferential direction. The arc 314A extends along an imaginary circle centered on the rotation axis AX. The first wall 314B extends radially inward from one end of the arc 314A in the circumferential direction. The second wall 314C extends radially inward from the other end of the arc 314A in the circumferential direction. Flow channels 316 are defined between the guides 314 and the motor compartment 21.

When the fan 12 rotates as driven by the motor 6, air flows into the motor compartment 21 through the inlets 19, and air inside the motor compartment 21 is discharged through the outlets 20. Air discharged through the outlets 20 flows toward the front end of the anvil 10 along the guides 314.

For example, a screwing operation on a workpiece may produce dust. More specifically, the tip tool attached to the anvil 10 may produce dust while rotating. The dust is blown by air discharged through the outlets 20 and flowing toward the front end of the anvil 10 along the guides 314.

The rear cover 3 and the rear cover 3N are replaceable with each other, thus allowing the user of the power tool 1 to customize the power tool 1 as appropriate. The rear cover 3 replaced with the rear cover 3N allows the power tool 1 to serve as a blower.

### 15. Fifteenth Embodiment

A fifteenth embodiment will be described. The same or corresponding components as those in the above embodiments are given the same reference numerals herein and will be described briefly or will not be described.

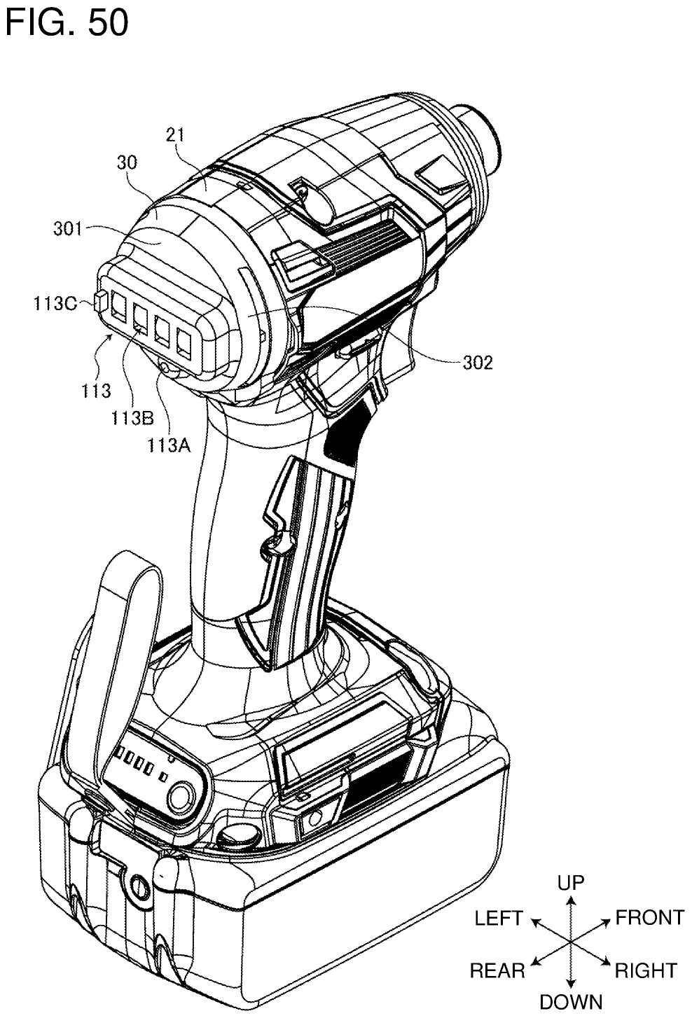

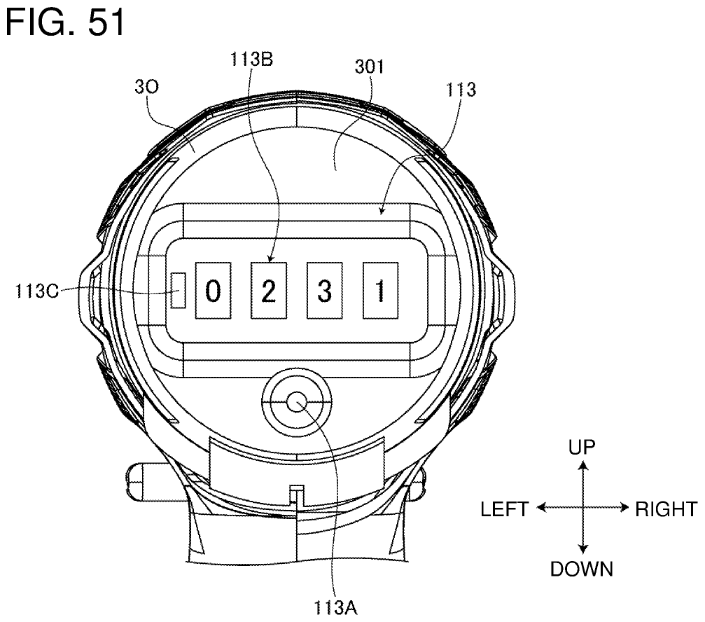

FIG. 50 is a rear perspective view of a power tool 1 according to the present embodiment. FIG. 51 is a rear view of an upper portion of the power tool 1.

As shown in FIGS. 50 and 51, the rear cover 3 described in the above first embodiment is replaceable with a rear cover 3O including an analog counter 113. The rear cover 3O including the analog counter 113 differs from the rear cover 3 in shape. The analog counter 113 differs from the rear cover 3 in composition and color.

Similarly to the rear cover 3, the rear cover 3O also includes the cover plate 301 and the cover cylinder 302. The cover cylinder 302 protrudes frontward from the rim of the cover plate 301 and surrounds the rear of the motor compartment 21. The rear cover 3O holds the rear rotor bearing 37. The rear cover 3O is attachable to and detachable from the motor compartment 21. The rear cover 3O is fastened to the motor compartment 21 simply through engagement between them. The analog counter 113 is fixed to the rear surface of the cover plate 301.

The analog counter 113 includes a count button 113A, a display 113B, and a reset button 113C.

The rear cover 3 and the rear cover 3O are replaceable with each other, thus allowing the user of the power tool 1 to customize the power tool 1 as appropriate. The analog counter 113 allows the user of the power tool 1 to count, for example, the number of screws tightened. In response to the count button 113A being pressed, the number of screws is counted, and the count appears on the display 113B. In response to the reset button 113C being pressed, the display 113B is reset.

### 16. Sixteenth Embodiment

A sixteenth embodiment will be described. The same or corresponding components as those in the above embodiments are given the same reference numerals herein and will be described briefly or will not be described.

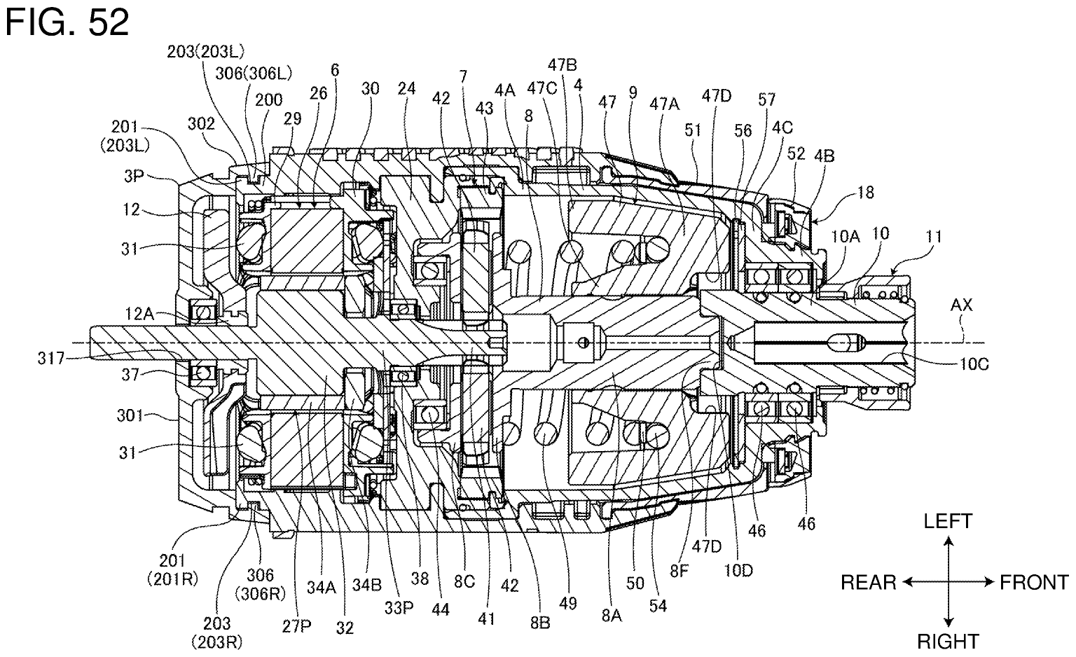

FIG. 52 is a horizontal sectional view of an upper portion of a power tool 1 according to the present embodiment. As shown in FIG. 52, the rear cover 3 described in the above first embodiment is replaceable with a rear cover 3P having an opening 317 in the center of the cover plate 301. The rear cover 3P including the opening 317 differs from the rear cover 3 in shape.

Similarly to the rear cover 3, the rear cover 3P also includes the cover plate 301 and the cover cylinder 302. The cover cylinder 302 protrudes frontward from the rim of the cover plate 301 and surrounds the rear of the motor compartment 21. The rear cover 3P holds the rear rotor bearing 37. The rear cover 3P is attachable to and detachable from the motor compartment 21. The rear cover 3P is fastened to the motor compartment 21 simply through engagement between them.

The rotor 27 described in the above first embodiment is replaceable with a rotor 27P including a rotor shaft 33P protruding rearward from the rear cover 3P through the opening 317. The rotor shaft 33P in the rotor 27P extends through the opening 317.

The rear cover 3 and the rear cover 3P are replaceable with each other, thus allowing the user of the power tool 1 to customize the power tool 1 as appropriate. The rotor shaft 33P has its rear end protruding rearward from the rear cover 3P, allowing intended use of its rotational force.

### 17. Seventeenth Embodiment

A seventeenth embodiment will be described. The same or corresponding components as those in the above embodiments are given the same reference numerals herein and will be described briefly or will not be described.

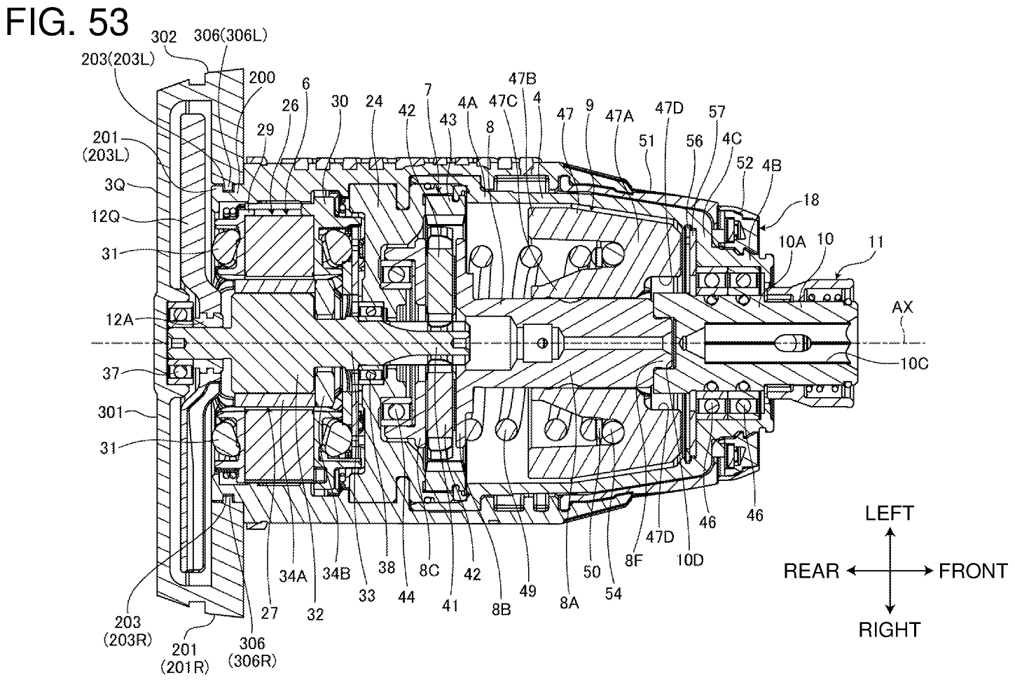

FIG. 53 is a horizontal sectional view of an upper portion of a power tool 1 according to the present embodiment. As shown in FIG. 53, the rear cover 3 described in the above embodiments is replaceable with a rear cover 3Q that is radially larger than the rear cover 3. The rear cover 3Q has a larger outer diameter than the rear cover 3. The rear cover 3Q differs from the rear cover 3 in shape and size.

Similarly to the rear cover 3, the rear cover 3Q also includes the cover plate 301 and the cover cylinder 302. The cover cylinder 302 protrudes frontward from the rim of the cover plate 301 and surrounds the rear of the motor compartment 21. The rear cover 3Q holds the rear rotor bearing 37. The rear cover 3Q is attachable to and detachable from the motor compartment 21. The rear cover 3Q is fastened to the motor compartment 21 simply through engagement between them.

The fan 12 described in the above first embodiment is replaceable with a fan 12Q that is radially larger than the fan 12.

The rear cover 3 and the rear cover 3Q are replaceable with each other, thus allowing the user of the power tool 1 to customize the power tool 1 as appropriate. To use the fan 12Q larger than the fan 12, the user of the power tool 1 can replace the rear cover 3 with the rear cover 3Q.

### 18. Eighteenth Embodiment

An eighteenth embodiment will be described. The same or corresponding components as those in the above embodiments are given the same reference numerals herein and will be described briefly or will not be described.

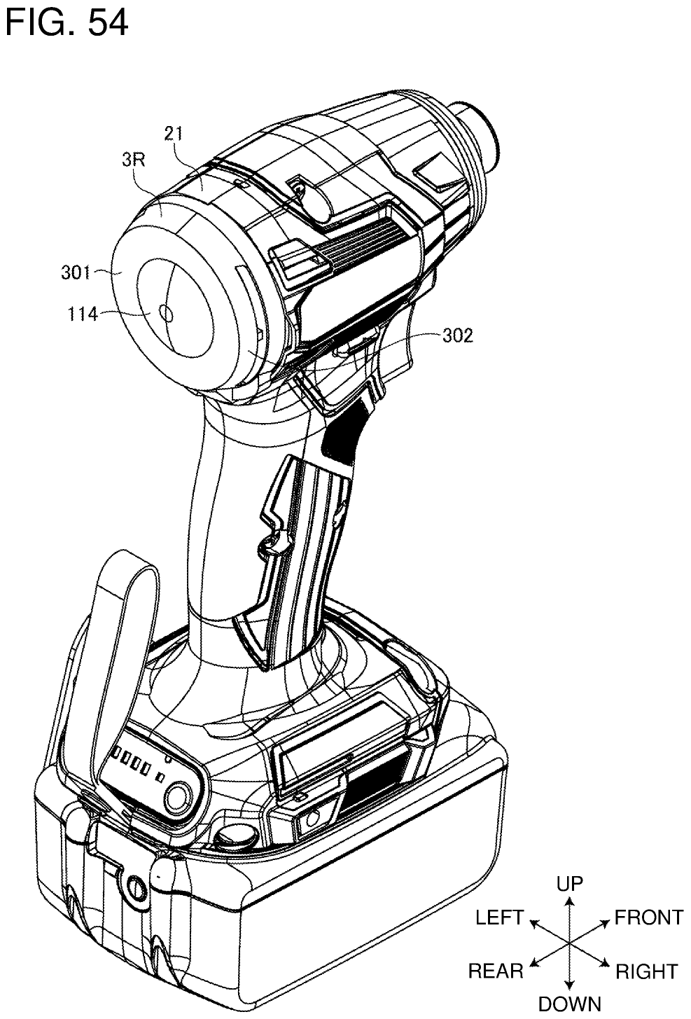

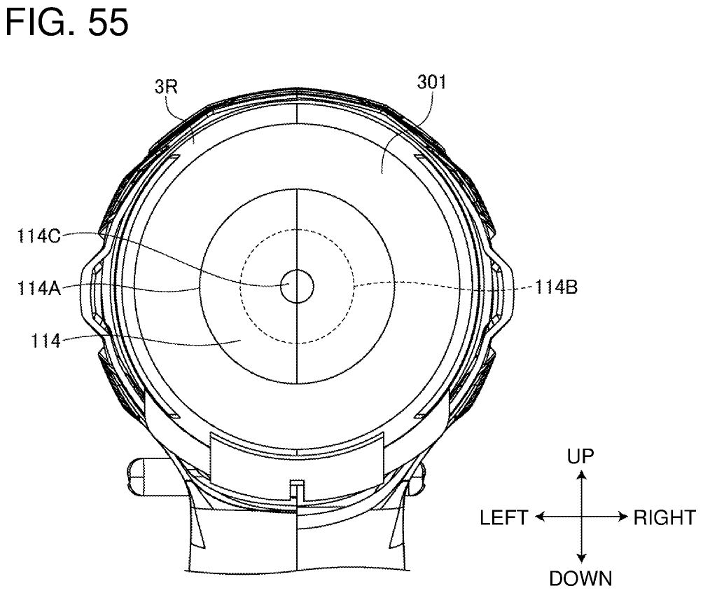

FIG. 54 is a rear perspective view of a power tool 1 according to the present embodiment. FIG. 55 is a rear view of an upper portion of the power tool 1.

As shown in FIGS. 54 and 55, the rear cover 3 described in the above first embodiment is replaceable with a rear cover 3R including a level 114. The rear cover 3R including the level 114 differs from the rear cover 3 in shape. The level 114 differs from the rear cover 3 in composition and color. The level 114 is a circular level.

Similarly to the rear cover 3, the rear cover 3R also includes the cover plate 301 and the cover cylinder 302. The cover cylinder 302 protrudes frontward from the rim of the cover plate 301 and surrounds the rear of the motor compartment 21. The rear cover 3R holds the rear rotor bearing 37. The rear cover 3R is attachable to and detachable from the motor compartment 21. The rear cover 3R is fastened to the motor compartment 21 simply through engagement between them. The level 114 is fixed to the rear surface of the cover plate 301.

The level 114 is a circular level. The level 114 includes a circular bubble tube 114A and a calibration mark 114B. A bubble 114C is inside the circular bubble tube 114A. When the power tool 1 is oriented to have the rotation axis AX of the motor 6 to be orthogonal to a horizontal plane, the bubble 114C is at the center of the calibration mark 114B.

The rear cover 3 and the rear cover 3R are replaceable with each other, thus allowing the user of the power tool 1 to customize the power tool 1 as appropriate. To drive a screw perpendicularly to a horizontal plane, for example, the user of the power tool 1 can perform a screwing operation while checking the orientation of the power tool 1 to cause the bubble 114C to be at the center of the calibration mark 114B. The user of the power tool 1 can check the level 114 to perform the screwing operation with the tip tool perpendicular to a horizontal plane. The screwing operation performed with the tip tool oriented perpendicularly reduces the likelihood that the tip tool slips out of the head of a screw (camming out).

### 19. Nineteenth Embodiment

A nineteenth embodiment will be described. The same or corresponding components as those in the above embodiments are given the same reference numerals herein and will be described briefly or will not be described.

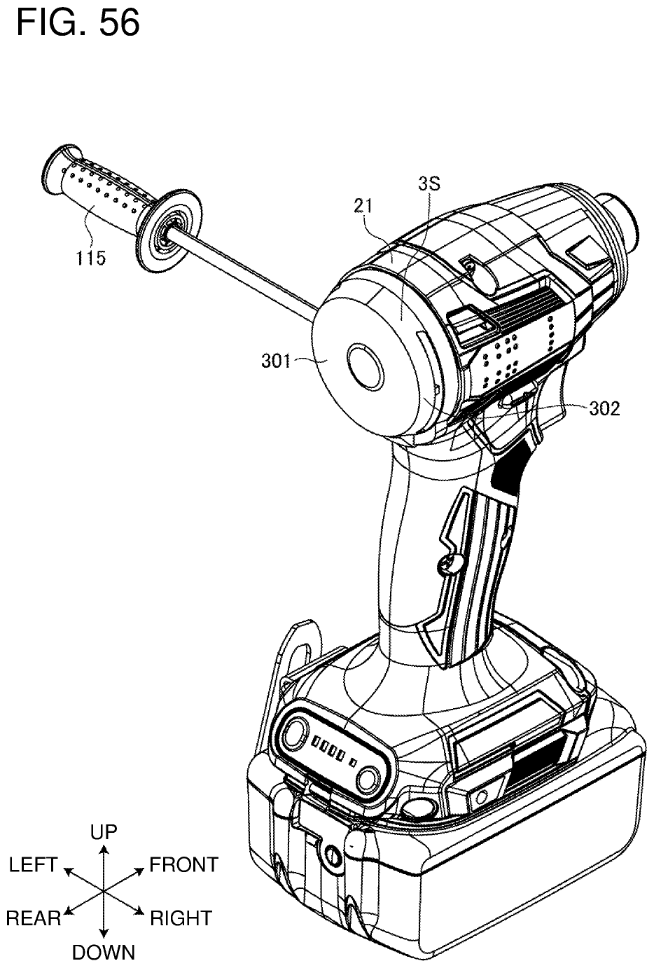

FIG. 56 is a rear perspective view of a power tool 1 according to the present embodiment. As shown in FIG. 56, the rear cover 3 described in the above first embodiment is replaceable with a rear cover 3S including a side handle 115. The rear cover 3S including the side handle 115 differs from the rear cover 3 in shape. The side handle 115 differs from the rear cover 3 in composition and color.

Similarly to the rear cover 3, the rear cover 3S also includes the cover plate 301 and the cover cylinder 302. The cover cylinder 302 protrudes frontward from the rim of the cover plate 301 and surrounds the rear of the motor compartment 21. The rear cover 3S holds the rear rotor bearing 37. The rear cover 3S is attachable to and detachable from the motor compartment 21. The rear cover 3S is fastened to the motor compartment 21 simply through engagement between them. The side handle 115 protrudes leftward from a left portion of the cover cylinder 302. The side handle 115 may protrude rightward from a right portion of the cover cylinder 302. The side handle 115 may protrude upward from an upper portion of the cover cylinder 302.

The rear cover 3 and the rear cover 3S are replaceable with each other, thus allowing the user of the power tool 1 to customize the power tool 1 as appropriate. The user of the power tool 1 can operate the trigger lever 14, for example, while holding the grip 22 with the right hand and gripping the side handle 115 with the left hand to receive a reaction force acting on the power tool 1 through the screwing operation.

### 20. Twentieth Embodiment

A twentieth embodiment will be described. The same or corresponding components as those in the above embodiments are given the same reference numerals herein and will be described briefly or will not be described.

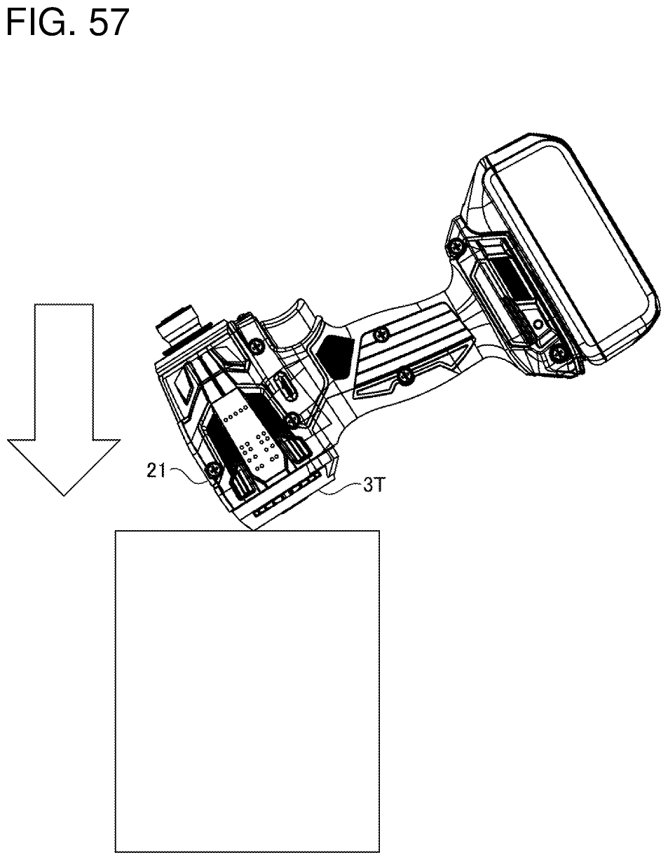

FIG. 57 is a schematic diagram of a power tool 1 according to the present embodiment. The rear cover 3 described in the first embodiment above is formed form a synthetic resin. As shown in FIG. 57, the rear cover 3 described in the above first embodiment is replaceable with a rear cover 3T formed from metal. The rear cover 3T is formed from, for example, iron. The rear cover 3T differs from the rear cover 3 in composition.

Similarly to the rear cover 3, the rear cover 3T also includes the cover plate 301 and the cover cylinder 302. The cover cylinder 302 protrudes frontward from the rim of the cover plate 301 and surrounds the rear of the motor compartment 21. The rear cover 3T holds the rear rotor bearing 37. The rear cover 3T is attachable to and detachable from the motor compartment 21. The rear cover 3T is fastened to the motor compartment 21 simply through engagement between them.

The rear cover 3 and the rear cover 3T are replaceable with each other, thus allowing the user of the power tool 1 to customize the power tool 1 as appropriate. The rear cover 3T is formed from hard metal and thus is less susceptible to deformation when the power tool 1 is dropped. The rear cover 3T is formed from hard metal. The user of the power tool 1 can strike a striking target with the rear cover 3T.

### 21. Other Embodiments

In the above embodiments, the power tool 1 is an impact driver. The power tool 1 may be an impact wrench or a driver drill.

In the above embodiments, the power tool 1 may use utility power (alternating-current power supply) in place of the battery pack 25.

### REFERENCE SIGNS LIST

1 power tool
2 housing
2L left housing
2R right housing
2S screw
3 rear cover
3B rear cover
3C rear cover
3D rear cover
3D1 rear cover
3D2 rear cover
3D3 rear cover
3E rear cover
3F rear cover
3G rear cover
3H rear cover
31 rear cover
3J rear cover
3K rear cover
3L rear cover
3M rear cover
3N rear cover
3O rear cover
3P rear cover
3Q rear cover
3R rear cover
3S rear cover
3T rear cover
4 hammer case
4A larger cylinder
4B smaller cylinder
4C connecting portion
6 motor
7 reducer
8 spindle
8A spindle shaft
8B first flange
8C second flange
8D joint
8F spindle protrusion
8G spindle groove
9 striker
10 anvil (output unit)
10A anvil shaft
10B anvil projection
10C tool hole
10D anvil recess
11 tool holder
12 fan
12A bush
12Q fan
13 battery mount
14 trigger lever
15 forward-reverse switch lever
16 mode switch hand button
16A circuit board
16B switch
18 light assembly
18A circuit board
18B light emitter
18C optical member
19 inlet
20 outlet
21 motor compartment
22 grip
23 battery holder
24 bearing box
24A rear annular portion
24B front annular portion
24C connecting portion
25 battery pack
26 stator
27 rotor
27P rotor
28 stator core
29 rear insulator
30 front insulator
30S screw
31 coil
32 rotor core
33 rotor shaft
33P rotor shaft
34A rotor magnet
34B sensor magnet
35 sensor board
36 fusing terminal
37 rear rotor bearing
38 front rotor bearing
41 pinion gear
42 planetary gear
42P pin
43 internal gear
44 spindle bearing
45 O-ring
46 anvil bearing
47 hammer
47A body
47B outer cylinder
47C inner cylinder
47D hammer projection
47E recess
47G hammer groove
48 ball
49 coil spring
50 washer
51 hammer case cover
52 light cover
54 ball
56 washer
57 support
71 ball
72 leaf spring
73 sleeve
74 coil spring
75 positioner
76 support recess
80 tool
100 luminous material portion
101 hook portion
102 socket
103 connector
104 connector
105 tool holder
106 tool
107 holding groove
108 rotation assembly
109 tool holder
110 holding hole
111 plate
112 communicator
113 analog counter
113A count button
113B display
113C reset button
114 level
114A circular bubble tube
114B calibration mark
114C bubble
115 side handle
200 housing cylinder
201 housing tab
201A slope
201B front surface
201L housing tab
201R housing tab
202 hook
202A arm
202B basal end
202C distal end
202D hook portion
203 receiving portion
203L receiving portion
203R receiving portion
204 elastic member
210 cylindrical portion
211 support surface
220 fixing portion
301 cover plate
302 cover cylinder
303 pillar
304 protrusion
305 receiving portion
306 cover tab
306L cover tab
306R cover tab
307 middle rear plate
308 side rear plate
308L side rear plate
308R side rear plate
309 middle lower plate
310 side lower plate
310L side lower plate
310R side lower plate
311 rib
312 engagement portion
313 hole
314 guide
314A arc
314B first wall
314C second wall
315 recess
316 flow channel
317 opening
320 protrusion
330 screw
340 protrusion
350 screw
AX rotation axis

What is claimed is:

1. A power tool, comprising:
a motor including a rotor and a stator, the rotor being rotatable about a rotation axis extending in a front-rear direction;
an output unit located frontward from the motor and rotatable in response to a rotational force from the rotor;
a motor compartment accommodating the motor;
a grip extending downward from the motor compartment;
a rear rotor bearing supporting a rear portion of the rotor; and
a rear cover covering an opening at a rear end of the motor compartment, the rear cover holding the rear rotor bearing,
wherein the motor compartment includes
a guide configured to guide the rear cover in a first circumferential direction and frontward,
a front-rear restrictor configured to restrict front-rear movement of the rear cover being guided by the guide, and
a circumferential restrictor configured to restrict circumferential movement of the rear cover being restricted from the front-rear movement.

2. The power tool according to claim 1, wherein
the motor compartment includes
a support surface surrounding the rotation axis and facing rearward,
a housing cylinder protruding rearward from the support surface and defining the opening, and
a housing tab protruding radially outward from an outer circumferential surface of the housing cylinder, and
the guide is located on the housing tab.

3. The power tool according to claim 2, wherein
the housing tab has a slope sloping frontward in the first circumferential direction, and
the guide includes the slope.

4. The power tool according to claim 3, wherein
the front-rear restrictor is at least partially located on the housing tab.

5. The power tool according to claim 4, wherein
the housing tab has a front surface facing frontward,
the front-rear restrictor includes the front surface, and
the front surface restricts rearward movement of the rear cover.

6. The power tool according to claim 5, wherein
the support surface surrounds the housing cylinder,
the front surface faces the support surface with a space in between,
the front-rear restrictor includes the support surface, and
the support surface restricts frontward movement of the rear cover.

7. The power tool according to claim 6, wherein
the rear cover includes a cover tab in contact with the housing tab, and
the cover tab is guided along the slope and is located between the front surface and the support surface.

8. The power tool according to claim 7, wherein
the rear cover includes a cover cylinder surrounding the housing cylinder, and
the cover tab is located on an inner circumferential surface of the cover cylinder.

9. The power tool according to claim 8, wherein
a plurality of the housing tabs are located circumferentially at intervals, and a plurality of the cover tabs are located circumferentially at intervals.

10. The power tool according to claim 1, wherein
the rear cover includes a cover tab being guided by the guide.

11. The power tool according to claim 10, wherein
the front-rear restrictor restricts front-rear movement of the cover tab.

12. The power tool according to claim 2, wherein
the circumferential restrictor is at a position different from a position of the front-rear restrictor.

13. The power tool according to claim 12, wherein
the circumferential restrictor includes a hook including a hook portion hooked on an engagement portion on the rear cover.

14. The power tool according to claim 13, wherein
the hook includes an arm having a basal end fixed to the motor compartment and a distal end including the hook portion.

15. A power tool, comprising:
a motor including a rotor and a stator, the rotor being rotatable about a rotation axis extending in a front-rear direction;
an output unit located frontward from the motor and rotatable in response to a rotational force from the rotor;
a left motor compartment and a right motor compartment accommodating the motor;
a grip extending downward from the left motor compartment and the right motor compartment;
a rear rotor bearing supporting a rear portion of the rotor; and
a rear cover fastened to the left motor compartment and the right motor compartment fastened together only through engagement with a rear of the left motor compartment and a rear of the right motor compartment, the rear cover holding the rear rotor bearing.

16. The power tool according to claim 15, wherein
the left motor compartment and the right motor compartment are fastened together with a plurality of screws, and
the plurality of screws are located frontward from a rotor core in the rotor.

17. The power tool according to claim 15, wherein
the rear cover is located on a left of the left motor compartment and a right of the right motor compartment to prevent separation between the rear of the left motor compartment and the rear of the right motor compartment.

18. The power tool according to claim 1, wherein
the rear cover is replaceable with a second rear cover different from the rear cover in color.

19. The power tool according to claim 1, wherein
the rear cover is replaceable with a second rear cover different from the rear cover in composition.

20. A power tool, comprising:
a motor including a rotor and a stator, the rotor being rotatable about a rotation axis extending in a front-rear direction;
an output unit located frontward from the motor and rotatable in response to a rotational force from the rotor;
a motor compartment accommodating the motor;
a rear rotor bearing supporting a rear portion of the rotor; and
a first rear cover covering an opening at a rear end of the motor compartment and holding the rear rotor bearing, the first rear cover being replaceable with a second rear cover different from the first rear cover in shape.
